(19) United States
(12) Patent Application Publication
(10) Pub. No.: US 2026/0100562 A1
(43) Pub. Date: Apr. 9, 2026

(54) Modular Electrical System with Interchangeable Functional Components

(71) Applicant: Tracy Marshall Hitt, Atlanta, GA (US)

(72) Inventor: Tracy Marshall Hitt, Atlanta, GA (US)

(21) Appl. No.: 19/417,840

(22) Filed: Dec. 12, 2025

Related U.S. Application Data
(60) Provisional application No. 63/733,016, filed on Dec. 12, 2024.

(51) Int. Cl. H02G 3/08

(52) U.S. Cl. CPC H02G 3/081

(57) ABSTRACT

A modular electrical housing for building electrical systems is disclosed. The housing includes an internal void defined by two or more walls. A plurality of receiving terminals, including corresponding conductors, are located within the void and are configured to interface with a modular electrical component when it is inserted. The housing also includes wire ports configured to connect to a building's electrical wiring, thereby providing an electrical connection between the building wiring and the conductors of the receiving terminals. This configuration allows the housing to be permanently installed and wired, while a functional electrical component, such as a physical switch, a power outlet, or an intelligent networked controller, can be removably inserted into the housing's void at a later time without direct manipulation of the building wiring. The receiving terminals can include isolation channels, and at least one channel may be keyed to ensure proper orientation of the inserted component.

### BACKGROUND

The field of this disclosure relates generally to electrical systems of buildings, and more specifically to the installation of electrical components such as light switches, dimmers, and power outlets.

In conventional construction and renovation projects, the installation of wall-mounted electrical components is typically a multi-stage process performed by a licensed electrician. During an initial “rough-in” phase, an electrical box, such as a junction box or gang box, is mounted to a structural member of the building, such as a wall stud. Electrical wiring from the building's power distribution system is then routed into this box, leaving lengths of wire available for later connection.

After other construction phases, such as the installation of drywall and painting, are complete, an electrician returns for a “finish” or “trim-out” phase. During this second phase, the electrician connects the individual electrical component, for instance a switch or an outlet, to the building wiring that was left inside the box. This connection process involves manually stripping the insulation from the ends of each wire, such as the line, load, neutral, and ground wires, and physically securing them to corresponding screw terminals on the body of the electrical component.

### SUMMARY

The present disclosure provides for a modular electrical system, a modular electrical housing, and a modular electrical component. The system, in general, includes a modular electrical housing configured to be permanently installed and connected to a building's electrical wiring, and a modular electrical component configured to be removably inserted into the housing to provide a specific electrical function. This configuration simplifies the installation of electrical components, enhances safety by isolating electrical conductors, and provides flexibility for future upgrades or changes to the electrical components without requiring direct manipulation of the building's wiring.

By separating the permanent wiring infrastructure from the functional user-facing component, the installation process is streamlined. A licensed electrician can install and connect the modular electrical housing to the building's wiring during the initial “rough-in” phase of construction. This completes all the necessary high-voltage wiring work in a single visit. The final installation of a modular electrical component, such as a switch or outlet, can then be performed at a later stage by simply inserting the component into the housing, eliminating the need for an electrician to return for a separate “finish” phase to manually connect wires to each device.

This configuration enhances safety by enclosing and isolating the electrical conductors within the modular housing's receiving terminals. Once the housing is installed, there are no exposed live wires within the wall box, reducing the risk of accidental electrical shock during the installation of the functional component. The use of features such as isolation channels and keyed interfaces further improves safety by physically separating conductors and ensuring that a modular electrical component can only be inserted in the correct orientation, which prevents improper and potentially hazardous wiring connections.

Furthermore, the system provides significant flexibility for future modifications and upgrades. A homeowner or maintenance personnel can easily change the functionality of a wall fixture without interacting with the building's wiring. For example, a standard physical switch can be quickly swapped for a smart switch, a dimmer, a power outlet, or a networked controller by simply removing the old modular component and inserting a new one. This “plug and play” capability allows the electrical system to be adapted to new technologies or changing user needs without requiring the services of an electrician.

One object of the disclosure is to provide a modular electrical housing that can be installed and wired during a single “rough-in” phase of construction, thereby eliminating the need for a separate “finish” phase of wiring. Another object is to increase safety by enclosing electrical connection points within the housing and corresponding components, reducing exposure to live wires. A further object is to provide a “plug and play” system that allows various functional electrical components, such as switches, outlets, or smart controllers, to be easily installed, removed, or interchanged by a user. The system also provides for correctly oriented connections through the use of keyed interfaces, preventing improper wiring.

A still further object is to reduce wire clutter within the electrical housing, which is a common issue in traditional installations. This clutter occurs because excess lengths of electrical wiring remains inside the box to facilitate manual connection to a device's terminals. These excess wire lengths are then folded and compressed into the limited space behind the device. The present designs mitigate this issue by providing fixed wire ports on the housing itself. This allows the building wiring to be terminated in the housing itself, rather than having to be stored in the housing, thereby keeping the internal void of the housing substantially free from loose wires and simplifying the final insertion of the modular component.

In one aspect, a modular electrical housing is provided. The housing comprises an internal void defined by two or more walls. A plurality of receiving terminals, which include corresponding electrical conductors, are located within the void and are configured to interface with a modular electrical component. The housing further includes a plurality of wire ports that connect to the building's electrical wiring, thereby providing an electrical connection between the building wiring and the conductors of the receiving terminals. In some implementations, each receiving terminal may comprise an isolation channel to physically and electrically separate its conductor. At least one isolation channel may be a keyed isolation channel having a distinct shape to ensure a pre-specified orientation of an inserted component. The housing may also include a locking mechanism to secure the component. For multi-gang applications, the internal void may be partitioned into a plurality of distinct bays, each including its own set of receiving terminals.

In another aspect, a modular electrical component is provided for insertion into the modular electrical housing. The component comprises a front face with a user interface and a back portion configured to be inserted into the housing's internal void. A plurality of housing conductor interfaces are located on the back portion. Each housing conductor interface includes a conductor configured to electrically connect with a corresponding receiving terminal of the housing when the component is inserted. The user interface on the front face may take various forms, such as a physical actuator (e.g., a switch or dimmer), one or more electrical power receptacles, or a display screen for presenting a graphical user interface. In some implementations, the component may include a network port for data connectivity. At least one housing conductor interface may be a keyed interface shaped to mate with a corresponding keyed receiving terminal in the housing.

In yet another aspect, a modular electrical system is provided. The system comprises the modular electrical housing and the modular electrical component as described above. When the back portion of the modular electrical component is inserted into the internal void of the modular electrical housing, the plurality of housing conductor interfaces on the component establish a secure electrical connection with the plurality of receiving terminals in the housing. The system may include corresponding keyed terminals and interfaces to ensure proper orientation and a locking mechanism, with parts on both the housing and the component, to mechanically secure the component within the housing.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a front view of an example electrical housing.

FIG. 1B is a side view of the electrical housing of FIG. 1A.

FIG. 2A is a front view of another example electrical housing having a keyed isolation channel.

FIG. 2B is a side view of the electrical housing of FIG. 2A.

FIG. 3A is a front view of another example electrical housing having port extensions.

FIG. 3B is a side view of the electrical housing of FIG. 3A.

FIG. 4A is a front view of another example electrical housing.

FIG. 4B is a side view of the electrical housing of FIG. 4A.

FIG. 5A is a front view of another example electrical housing having five conductors.

FIG. 5B is a side view of the electrical housing of FIG. 5A.

FIG. 6A is a front view of another example electrical housing having a recessed interior.

FIG. 6B is a side view of the electrical housing of FIG. 6A.

FIG. 7A is a front view of an example converter insert for a modular electrical housing.

FIG. 7B is a side view of the converter insert of FIG. 7A.

FIG. 8A is a front view of an example modular outlet.

FIG. 8B is a back view of the modular outlet of FIG. 8A.

FIG. 9A is a perspective view illustrating the insertion of an example modular switch into a corresponding modular housing.

FIG. 9B is a perspective view of the modular switch of FIG. 9A fully inserted into the modular housing.

FIG. 10A is a perspective view illustrating the insertion of an example modular electrical device into a modular housing having a locking mechanism.

FIG. 10B is a perspective view of the modular electrical device of FIG. 10A secured within the modular housing by the locking mechanism.

FIG. 11A is a front view of an example modular outlet having a network connection.

FIG. 11B is a back view of the modular outlet of FIG. 11A.

FIG. 12A is a front view of another example modular housing.

FIG. 12B is a side view of the modular housing of FIG. 12A.

FIG. 13A is a front view of another example modular housing having keyed isolation channels.

FIG. 13B is a side view of the modular housing of FIG. 13A showing attached wire leads.

FIG. 14A is a front view of an example modular controller having a display screen.

FIG. 14B is a back view of the modular controller of FIG. 14A showing a network port.

FIG. 15A is a front view of an example modular virtual switch device.

FIG. 15B is a back view of the modular virtual switch device of FIG. 15A.

FIG. 16A is a front view of an example modular physical switch device.

FIG. 16B is a back view of the modular physical switch device of FIG. 16A.

FIG. 17 is a front view of an example modular multi-switch device for a multi-gang application.

FIG. 18 is a front view of an example modular multi-gang housing having partitioned bays.

FIG. 19 is a front view of another example modular multi-gang housing having partitioned bays with an alternative conductor arrangement.

Like reference numbers and designations in the various drawings indicate like elements.

### DETAILED DESCRIPTION

This specification describes a new electrical housing that reduces the amount of time required to install various electrical components, such as light switches, dimmers, power outlets, and other electrical accessories/controls. The described electrical housings also allow for plug and play installation and/or replacement of electrical accessories/controls. These new electrical housings also reduce the amount of wire located within the electrical housing relative to existing electrical housings, and reduce the risk of inadvertent shock and/or electrical shorts by limiting exposure of electrical conductors, and maintaining distance between different conductors (e.g., hot, neutral, load, and ground).

The plug and play functionality of these new electrical housings also simplifies installation of switches and/or outlets, and ensures that light switches and/or outlets are correctly wired, for example, by making secure connections to all power lines, and by only allowing insertion of switches and/or outlets in the appropriate orientation. Furthermore, the new electrical housings simplify the “rough-in” process during construction of a building by completing essentially all of the work required to be performed by licensed electricians at the “rough-in” process, rather than requiring the electrician to return to the construction site a second time (e.g., after painting is complete) to wire the switches, outlets, and/or other electrical components. Rather, since all of the electrical connections are made at the time the electrical housings are installed, the switches and outlets can simply be plugged into the housings.

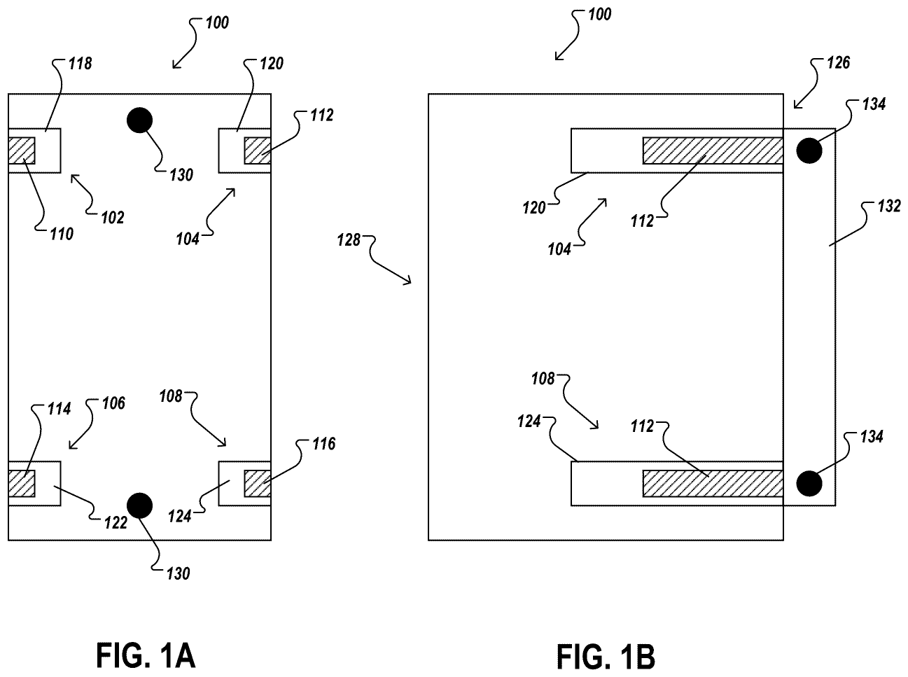

FIGS. 1A and 1B are respectively front and side views of an example electrical housing 100, which is also referred to as a “housing” for brevity. The front view of the housing 100 shows the interior configuration of four receiving terminals 102, 104, 106, and 108. Each of the four receiving terminals 102-108 are located on sides of the housing 100, but they could be located on the top and bottom, on one side, all on the top or all on the bottom of the housing 100, on the back of the housing 100, or some other combination of locations on the housing 100. The four receiving terminal 102, 104, 106, 108 and their corresponding components are located within a void defined by two or more walls of the housing 100. As shown, the housing 100 includes two side walls, a top wall, a bottom wall, and a back wall. The back wall connects between at least two of the other walls and can provide structural support for the housing 100.

The receiving terminals 102, 104, 106, and 108 are shown as being offset from the top and the bottom of the housing 100. The distance from the top and bottom can be selected as desired and/or as required by building codes in the area where the housing 100 is being used.

The receiving terminals 102, 104, 106, and 108 respectively include conductors 110, 112, 114, and 116 that are inside of respective isolation channels 118, 120, 122, and 124. The isolation channels 118, 120, 122, and 124 can be formed of the same material as the rest of the housing 100, or formed from a different material. For example, the isolation channels 118, 120, 122, and 124 can be formed from plastic, rubber, or another non-conductive material that isolates the conductors 110, 112, 114, and 116 from each other and/or from other portions of the interior of the housing 100. The isolation channels 118, 120, 122, and 124 are shown as rectangular in shape, but they can be other shapes, such as triangular, circular, oval, star shaped, or another shape.

The isolation channels 118, 120, 122, and 124 can extend from the back 126 of the housing 100 toward the front 128 of the housing 100. The back 126 of the housing 100 is the surface of the housing that is opposite the opening into which the switch or power outlet is inserted, and the front 128 of the housing 100 has an opening into which the switch, power outlet, or other electrical component is inserted. In other words, the front 128 of the housing 100 is configured to receive a switch, power outlet or another electrical component. The front 128 of the housing will face the exterior of the wall cavity when installed.

In some implementations, the isolation channels 118, 120, 122, and 124 can extend further toward the front 128 of the housing 100 than the conductors 110, 112, 114, and 116. By forming the isolation channels 118, 120, 122, and 124 to extend further toward the front 128 of the housing 100, than the conductors 110, 112, 114, and 116, the risk of shock and/or short circuits is reduced because the conductors 110, 112, 114, and 116 are recessed relative to the end of the isolation channels.

The isolation channels 118, 120, 122, and 124 are formed at a pre-specified distance from the conductors 110, 112, 114, and 116, thereby leaving space (e.g., forming a channel) between the conductors 110, 112, 114, and 116 and the material used to form the isolation channels 118, 120, 122, and 124. As discussed in more detail below, this facilitates the proper insertion of modular (e.g., plug and play) switches or outlets into the housing 100.

The housing 100 has two screw holes 130 that are located near (e.g., at a pre-specified distance from) the top 132 and the bottom 134 of the housing 100. The screw holes 130 can be formed within/from the same material as the rest of the housing 100, the isolation channels 118, 120, 122, and 124, or another material. For example, the screw holes 130 can be formed from/within plastic.

The housing 100 includes a conductor interface 132 that is located on the back 126 of the housing 100. The conductor interface 132 is configured to receive and secure conductors of electrical wires. For example, the conductor interface 132 can include components that clamp, squeeze, grip, or otherwise secure wires to the housing 100. In some implementations, the conductor interface 132 can include a lever clamp, or another clamping component that opens and closes to enable insertion of an electrical wire (e.g., in the open position), and clamp the electrical wire (e.g., in the closed position). In some implementations, the conductor interface 132 can be a screw mechanism that opens a space for the electrical wire when the screw is loosened/partially removed, and presses down on the electrical wire to secure it to a corresponding conductor when the screw is tightened.

The exterior of the conductor interface 132 can be formed from the same material as the rest of the housing 100, the isolation channels 118, 120, 122, and 124, or another material. For example, the exterior of the conductor interface 132 can be formed from plastic.

The conductor interface 132 includes wire ports 134 that are configured to receive electrical wires for each of the conductors 110, 112, 114, and 116. The wire ports 134 are shown as circular, but can be other shapes. The clamping component (e.g., lever clamp, screw, etc.) that secures the wires in the conductor interface 132 can open and close access to the wire ports 134 when opened/closed. The interior of the wire ports 134 and/or a portion of the clamping component can be formed from an electrically conductive material, and connected to the conductors 110, 112, 114, and 116, to provide an electrical connection between the wires inserted into/secured in the wire ports 134. In the side view of FIG. 1B, only two wire ports 134 are shown for the isolation channels 120 and 124 (e.g., connected to the conductors 112 and 116), but similar wire ports are also provided for the isolation channels 102 and 106 (e.g., connected to the conductors 110 and 114).

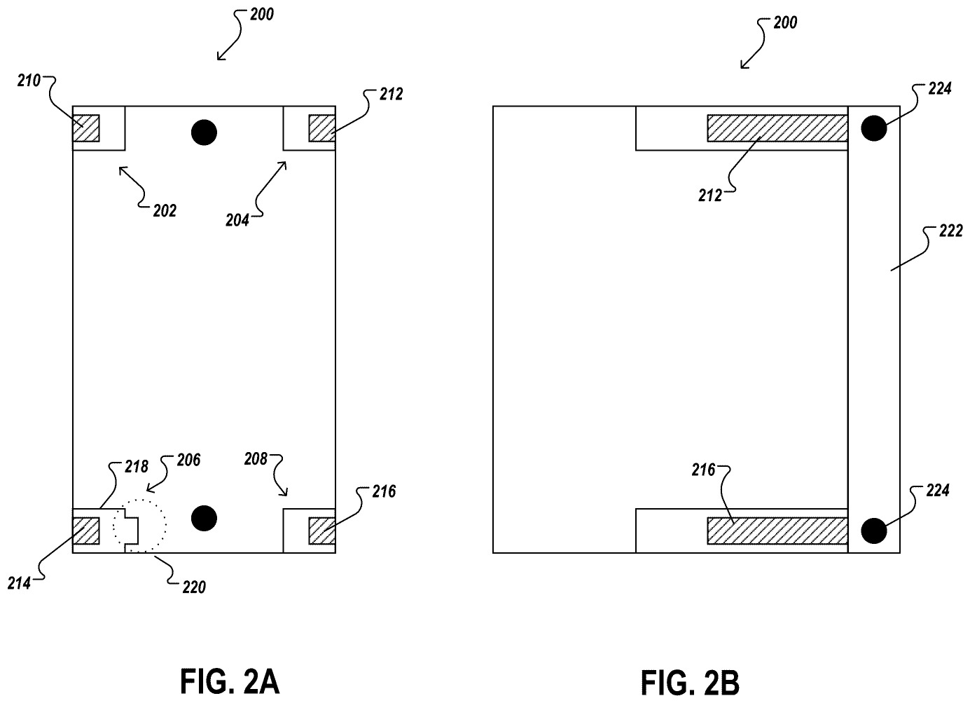

FIGS. 2A and 2B are respectively front and side views of another example electrical housing 200. Similar to FIG. 1A, the front view of the housing 200 in FIG. 2A shows the interior configuration of four receiving terminals 202, 204, 206, and 208. Each of the four receiving terminals 202-208 are located in the four corners of the housing 200, and respectively include the conductors 210, 212, 214, and 216. The receiving terminals 202-208 are similar to the receiving terminals 102-108, so the similarities are not discussed again here. However, the receiving terminal 206 illustrates an example of a keyed isolation channel 218 that has a different shape than the isolation channels 118, 120, 122, and 124. As shown, the isolation channel 218 includes a protruded area 220 that is not included in the isolation channels of the receiving terminals 202, 204, or 208. Inclusion of this protruded area 220 (or another shape difference) in the isolation channel 218 ensures that modular switches/outlets are installed in the appropriate orientation. For example, when the modular switch/outlet has a corresponding shape on one of the terminals, it will only be fully insertable into the housing 200 when properly oriented so that the differently shaped (e.g., keyed) terminal of the modular switch/outlet is aligned with the isolation channel 218.

The orientation of insertion of a modular switch/outlet (or other electrical component) can be dictated by a pre-specified wiring configuration. For example, the conductor 214 within the keyed isolation channel 218 can be designated as the ground (earth) terminal, such that the ground connection of modular switch, outlet, or other electrical component must be inserted into the keyed isolation channel 218 in order for connections between connectors of the keyed isolation channel 218 to come into contact with the conductors 210-216. In this way, the keyed isolation channel 218 prevents improper electrical connections between the modular electrical components and the conductors 210-216 of the housing 200. The location of the keyed isolation channel 218 is not critical, and can be formed at other locations of the housing 200. Furthermore, the keyed isolation channel 218 need not include a conductor. For example, the keyed isolation channel 218 could simply be an empty channel that prevents improper insertion of a modular electrical component. In some implementations, the keyed isolation channel could be configured as a protrusion that prevents improper insertion of a modular electrical component.

In some implementations, the receiving terminals of the housing can include an additional safety feature, such as a shutter mechanism. This mechanism can be configured to keep the conductors (e.g., conductors 210-216) covered and inaccessible when no modular component is inserted. For example, a spring-loaded, non-conductive shutter could physically block the opening of one or more isolation channels. The shutter can be designed to be pushed open only by the insertion of a correctly shaped and sized modular electrical component. This provides the technical advantage of preventing foreign objects, such as a screwdriver or a child's finger, from making accidental contact with live electrical conductors, thereby significantly increasing the safety of the housing, especially before a modular component is installed.

The configuration of the housing 200 also differs from the housing 100 because the receiving terminals 202-208 are formed in the four corners of the housing 200. In contrast, the receiving terminals 102-108 of the housing 100 were formed on the sides (i.e., offset from the top and bottom of the housing 100). Other locations can be selected for the receiving terminals 202-208, as previously discussed with reference to FIGS. 1A-1B.

The side view of FIG. 2B is substantially the same as the side view of FIG. 1B, except that the conductor interface 222 extends from the top of the housing 200 to the bottom of the housing 200, and the wire ports 224 are relocated to be aligned with the conductors 212 and 216. It is not necessary to align the wire ports 224 with the conductors 212 and 216, but doing so can reduce the amount of material required to electrically connect the conductors 212 and 216 to their corresponding wire ports 224. The opposite side view of the housing 200 (not shown) would be similar to the side view of FIG. 2B except that the conductors 210 and 214 would be shown, and aligned with corresponding wire ports.

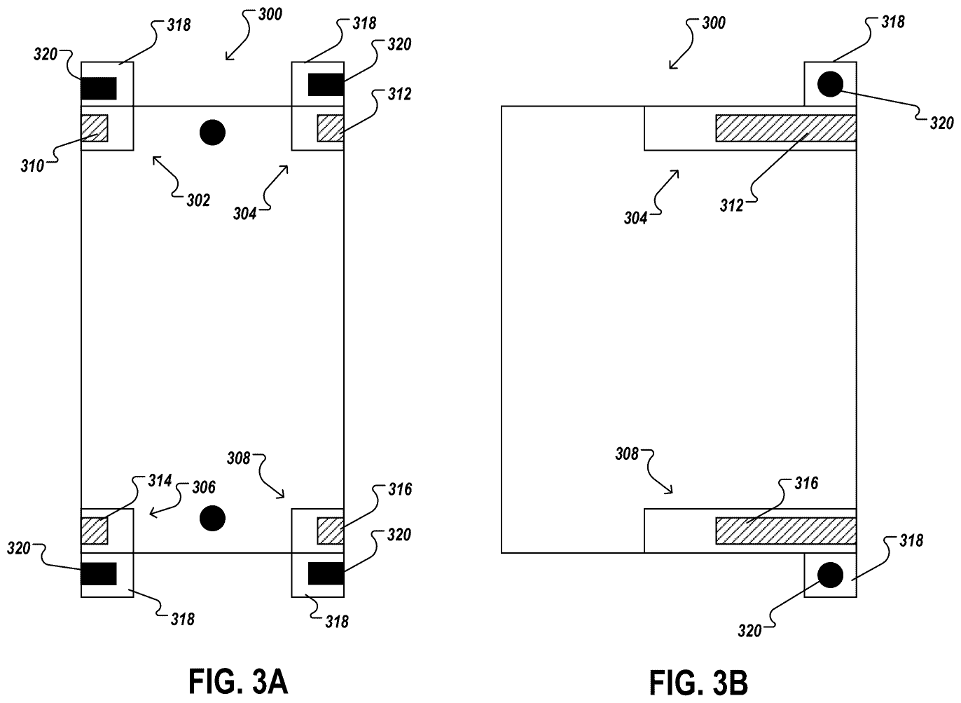

FIGS. 3A and 3B are respectively front and side views of another example electrical housing 300. Similar to FIGS. 1A and 2A, the front view of the housing 300 in FIG. 3A shows the interior configuration of four receiving terminals 302, 304, 306, and 308. Each of the four receiving terminals 302-308 are located in the four corners of the housing 300, and respectively include the conductors 310, 312, 314, and 316 inside the perimeter of the receiving terminals 302-308. The receiving terminals 302-308 are similar to the receiving terminals 102-108 (and 202-208), so the similarities are not discussed again here. However, the electrical housing 300 includes four port extensions 318 (e.g., tabs) that are located on the top and bottom of the housing 300. More specifically, the port extensions 318 are located between the side edges of the housing 300, where the side edges are those edges that extend from the top to the bottom of the housing 300 and from the front to the back of the housing 300. The front of the housing 300 is the exterior plane (e.g., between the top and the bottom) of the housing 300 that is configured to receive a modular switch/outlet.

The side view of FIG. 3B shows the relative locations of the conductors 312 and is substantially the same as the side view of FIG. 2B, but that the conductor interface 222 extends from the top of the housing 200 to the bottom of the housing 200, whereas the four port extensions 318 are on the top and bottom of the housing 300. The side view of FIG. 3B also differs from the side view of FIG. 2B in that the wire ports 320 are located above/below their corresponding conductors 310, 312, 314, and 316, respectively.

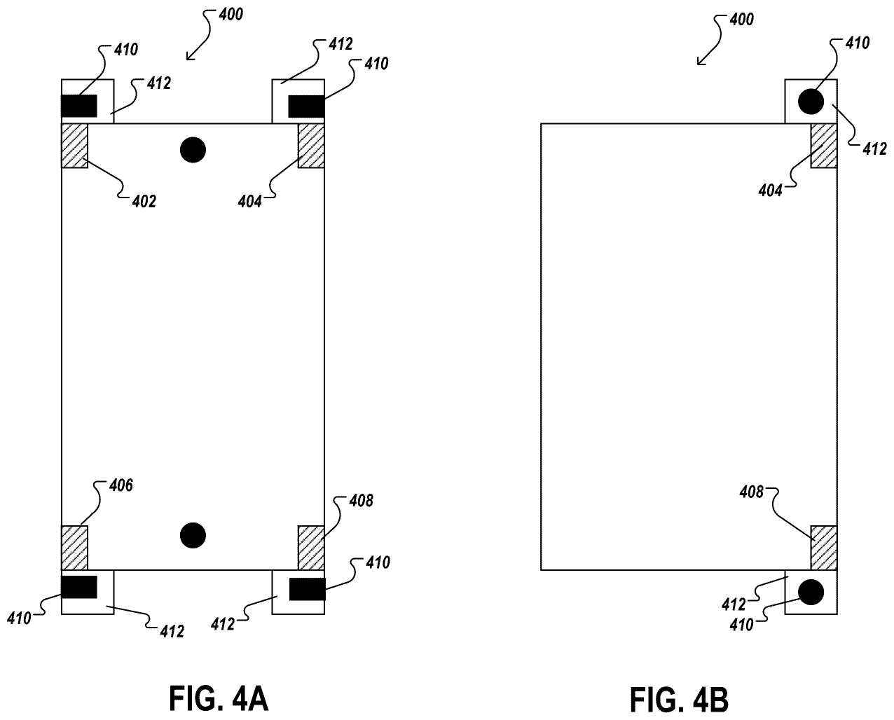

FIGS. 4A and 4B are respectively front and side views of another example electrical housing 400. The housing 400 includes conductors 402, 404, 406, and 408 that are located in the four corners of the housing 400, but the conductors 402, 404, 406, and 408 could be located in other locations, as long as the conductors are electrically separated from each other. For example, the conductors 402-408 could be located offset from the corners/edges of the housing.

Rather than being within isolation channels like the conductors previously discussed, the conductors 402-408 are not within isolation channels, although in some implementations they could be. Rather, the conductors 402-408 are configured to engage corresponding conductors on a modular switch/outlet that is inserted into the housing 400.

FIG. 4A shows the locations of wire ports 410 within four port extensions 412. The wire ports 410 are configured to receive/secure conductors from a power source, such as wires that are connected to a home's breaker box, as well as a conductor to a load (e.g., a light). The wire ports 410 can be similar to those previously discussed.

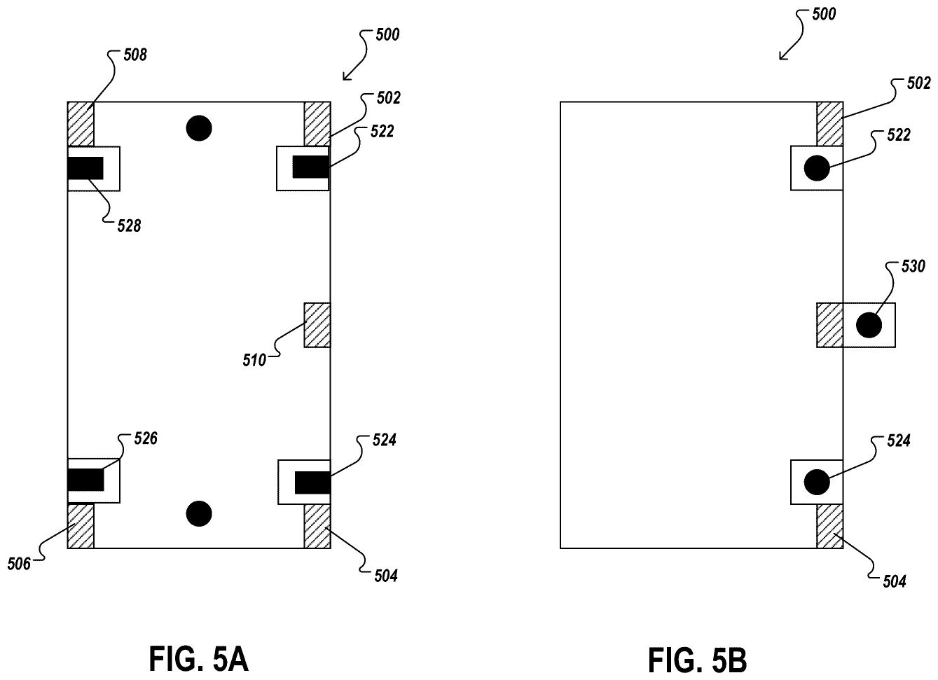

FIGS. 5A and 5B are respectively front and side views of another example electrical housing 500. The housing 500 is similar to the previously discussed housings, but the housing 500 has 5 conductors 502-510 instead of 4 conductors. The extra conductor 510 of the housing 500 can be used as a traveler port for three-way switch wiring (or another electrical connection), assuming that the other four conductors are used as ground, hot, neutral, and load as previously discussed.

The housing 500 also has five wire ports 520-530. The wire ports 520-528 are located on the interior sides and/or back of the housing 500 so that they are accessible from the sides and/or back of the housing 500, while the wire port 530 is shown as being located on the back of the housing 500. The locations of the wire ports 520-530 can be selected depending on the application and housing size restrictions.

More generally, the number of conductors and corresponding wire ports can be selected to accommodate various electrical wiring configurations. For example, to implement a 3-way switching application, which uses two switches to control a single load, two traveler wires are run between the locations of the two switches. In such a configuration, a housing with at least five conductors can be used at each switch location. A first housing can be configured to connect to a ground wire, a neutral wire, a hot wire from the power source, and the two traveler wires. A second housing can be configured to connect to the ground wire, the neutral wire, a load wire to the electrical device, and the same two traveler wires.

For more complex configurations, such as 4-way switching, additional conductors can be included. A 4-way switch is installed between two 3-way switches and requires connections for two pairs of traveler wires (an incoming pair from one switch and an outgoing pair to the other switch). Therefore, a housing configured to receive a modular 4-way switch could include at least six conductors: one for ground, one for neutral, and four for the two pairs of traveler wires. By extension, housings with additional conductors can be provided to support even more complex multi-way switching scenarios, with the number of conductors increasing to accommodate the required traveler wires.

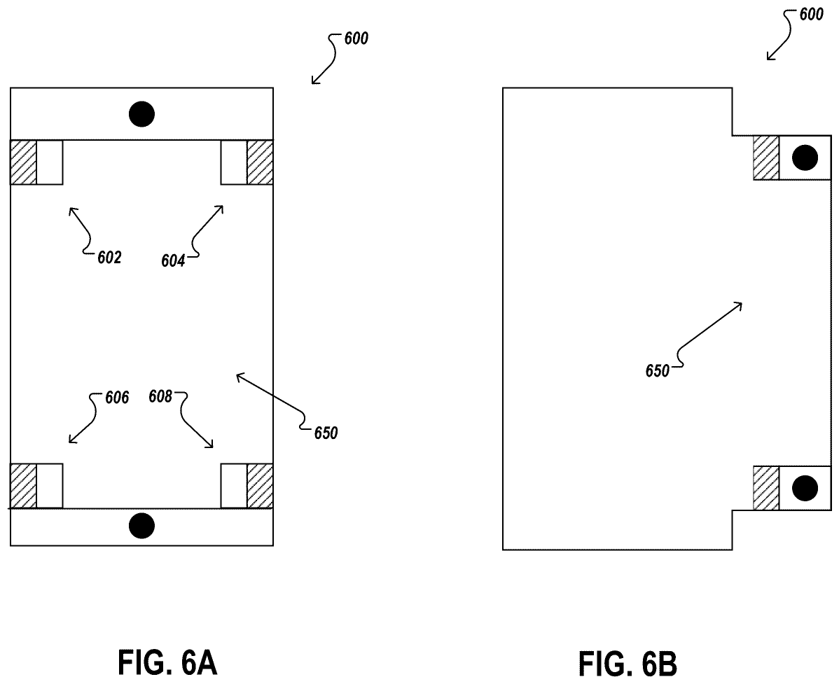

FIGS. 6A and 6B are respectively front and side views of another example electrical housing 600. The housing 600 is similar to the previously discussed housings, but the interior of the housing 600 has a recess 650 in which four receiving terminals 602, 604, 606, and 608 are located. Placing the receiving terminals in the recess can provide more space for modular switches/outlets to be inserted into the housing 600.

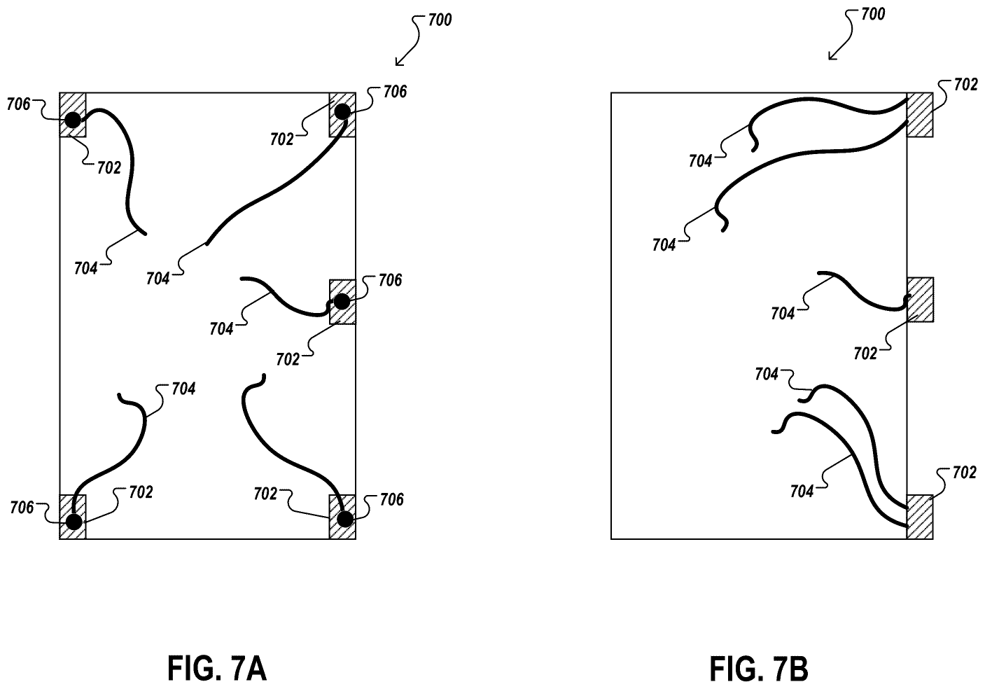

FIGS. 7A and 7B are front and side views of an example converter insert 700. The converter insert 700 is configured to be inserted into the housing 500 or another housing, and provide a modular to traditional wiring conversion. In other words, the converter insert 700 enables traditional wiring connections to be made when a housing, such as those discussed above, has already been installed. In this way, a traditional switch/outlet can be installed after one of the modular housings has been installed.

The converter insert 700 has five housing conductor interfaces 702 that are configured to electrically connect to conductors of the modular housings discussed above. For example, with reference to the housing 500 discussed above, the five housing conductor interfaces 702 are configured to engage the conductors 502-510 of the housing 500. Each of the housing conductor interfaces 702 has a corresponding wire 704 that is connected to the housing conductor interface 702, and provides an electrical connection point for connecting the wires of a traditional switch/outlet. More or fewer housing conductor interfaces 702 can be included as desired.

In some implementations, the housing conductor interfaces 702 can include wire connection points 706 that are configured to receive the corresponding wires 704 and/or wires of a traditional switch/outlet. For example, the wire connection points 706 can be similar to the wire ports previously discussed, and can be configured to secure the corresponding wires 704 and/or wires of switches/outlets to the housing interfaces 702. In some implementations, the wire connection points 706 can include a screw, spring, clamp, solder, or another securing mechanism that secures a wire in electrical connection to the housing conductor interfaces 702.

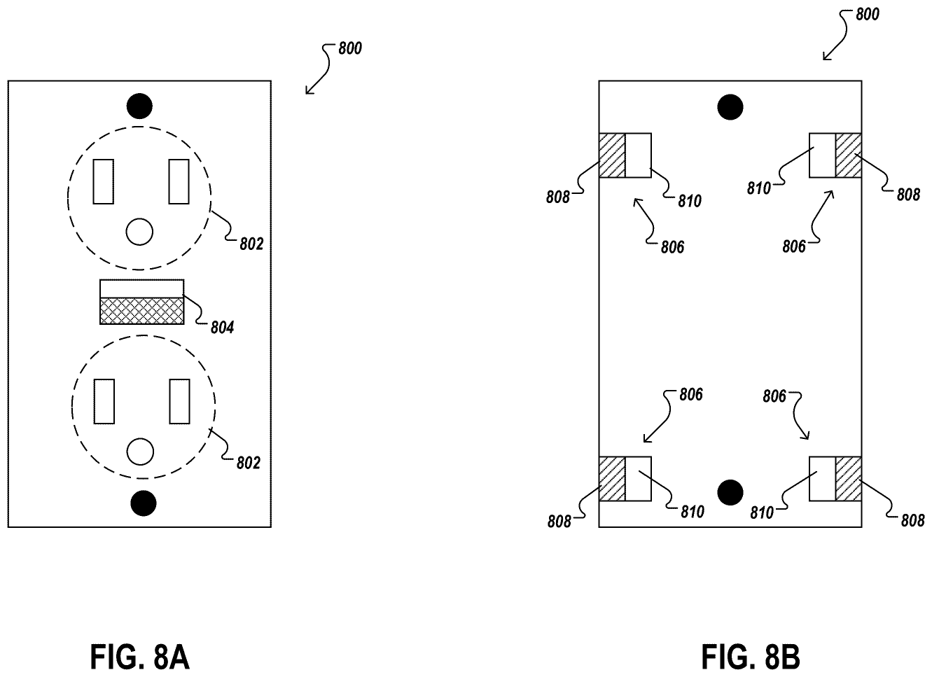

The converter insert 700 can have dimensions that enable the converter insert 700 to be inserted in the modular housings previously discussed. In situations where the modular housing includes isolation channels in which conductors are formed, the converter insert 700 can be formed to interface with the isolation channels, as discussed with reference to the outlet 800 of FIGS. 8A and 8B.

FIGS. 8A and 8B are front and back views of an example modular outlet 800. The modular outlet 800 is configured to be inserted into a modular housing, similar to those discussed above. The modular outlet 800 has two plug receptacles 802 and a USB port 804. The modular outlet 800 could be formed to include more or fewer plug receptacles 802 and/or more or fewer USB ports 804.

The back view of the modular outlet 800 includes four housing conductor interfaces 806. Each of the housing conductor interfaces 806 includes a conductor 808 configured to engage a corresponding conductor of a modular housing similar to those discussed above. For example, as shown, the four housing conductor interfaces 806 has a conductor 808 that is located within an isolation channel 810. In this way, the modular outlet 800 is configured to be inserted into a modular housing in which the conductors are protected by way of an isolation channel. The modular outlet 800 can also have a keyed isolation channel (not shown) configured to interface with a corresponding keyed isolation channel similar to those discussed above. In this way, insertion of the modular outlet 800 can be restricted to ensure proper alignment of the conductors 808 with appropriate corresponding (e.g., matching) conductors of the modular housing.

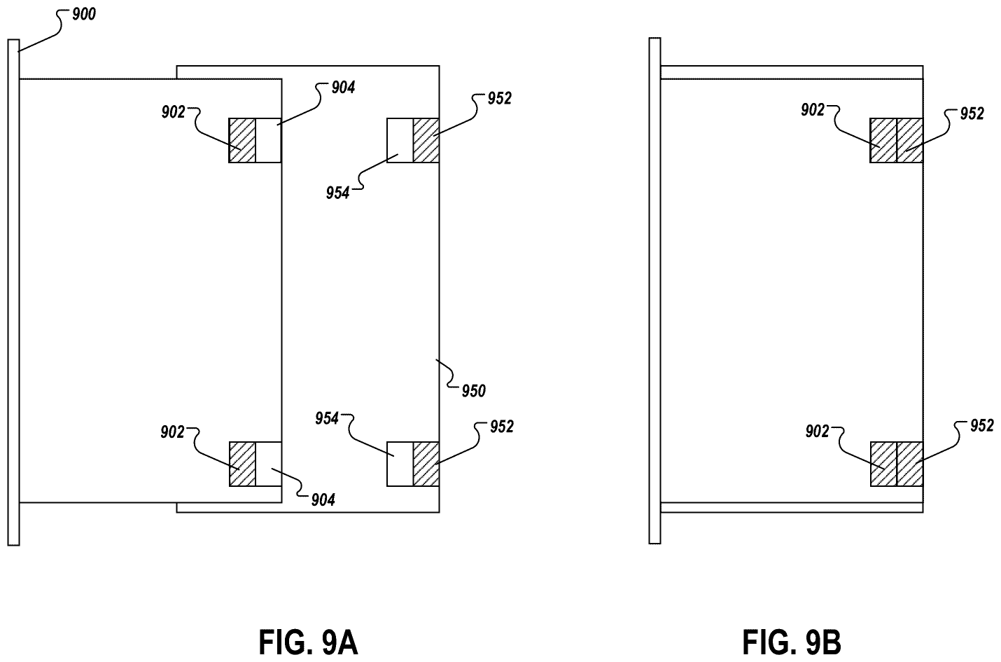

FIGS. 9A and 9B illustrate the insertion of an example modular switch 900 into a corresponding modular housing 950. As shown, the modular switch 900 includes conductors 902 that are located within isolation channels 904, which isolate the conductors 902 from inadvertent touching or shorting. The modular housing includes corresponding conductors 952 that are located within corresponding isolation channels 954 that isolate the conductors 952 from inadvertent touching or shorting.

As shown, the conductors 902 and 952 are configured to engage each other when the modular switch 900 is inserted completely into the modular housing 952. As shown, the space created by the isolation channels 904 and 954 are filled with the conductors 902 and 952 when the modular switch 900 is inserted into the modular housing 900, and the conductors 902 and 952 come into contact, thereby creating an electrical connection between the modular switch 900 and the modular housing 950. The conductors 952 are configured to be electrically connected to a power source, such as electrical wires of a residence or other structure. The electrical connection can be facilitated, for example, by way of a connection to a wire port similar to those discussed above.

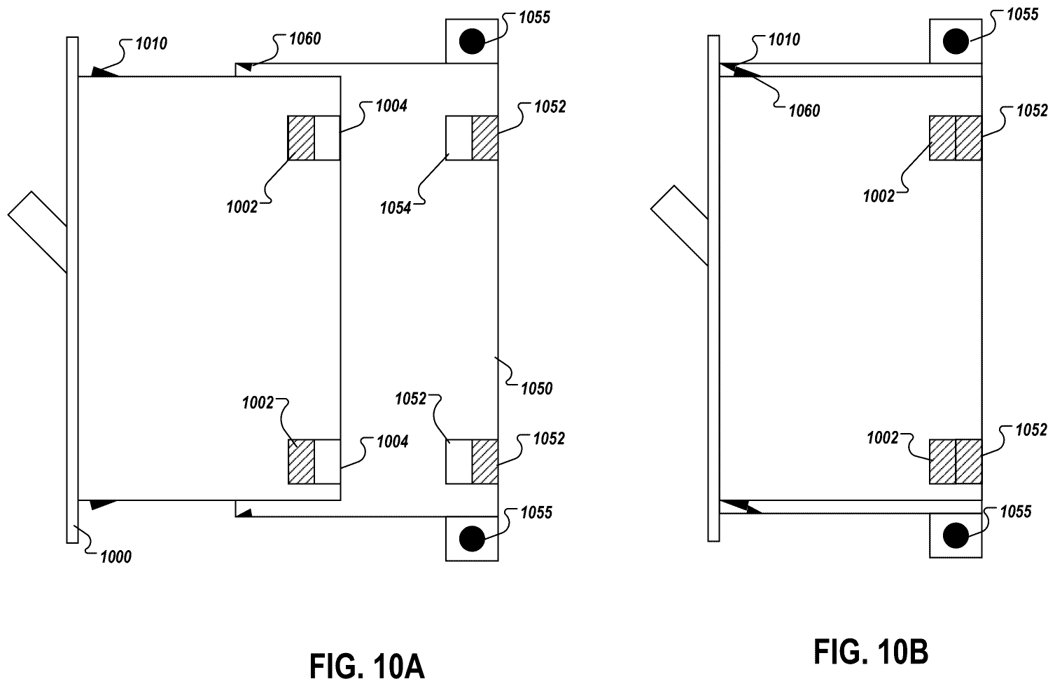

FIGS. 10A and 10B illustrate the insertion of an example modular electrical device 1000 into a modular housing 1050. As shown, the modular electrical device 1000 includes conductors 1002 that are located within isolation channels 1004, which isolate the conductors 1002 from inadvertent touching or shorting. As discussed elsewhere, the isolation channels 1004 are optional in some implementations. The modular housing 1050 includes corresponding conductors 1052 that are located within corresponding isolation channels 1054 that isolate the conductors 1052 from inadvertent touching or shorting. As shown, the conductors 1002 and 1052 are configured to engage each other when the modular electrical device 1000 is inserted completely into the modular housing 1052.

As shown, the space created by the isolation channels 1004 and 1054 are filled with the conductors 1002 and 1052 when the modular electrical device 1000 is inserted into the modular housing 1000, and the conductors 1002 and 1052 come into contact, thereby creating an electrical connection between the modular electrical device 1000 and the modular housing 1050.

The conductors 1052 are configured to be electrically connected to a power source, such as electrical wires of a residence or other structure, and a load. The electrical connection can be facilitated, for example, by way of a connection to wire ports 1054. Each of the wire ports 1055 are electrically connected to a corresponding one of the conductors 1052, and are each configured to secure a wire in a similar manner as discussed elsewhere in this specification. As shown, the wire ports 1055 are located on the sides of the modular housing 1050, but the wire ports could be on the back of the housing 1050 or in another location. In some implementations, a mating conductor (not shown) electrically connects each of the wire ports 1055 to a corresponding conductor 1052. The mating conductor can be routed on the back or through the housing 1000 depending on the application and size constraints.

The modular electrical device 1000 and the modular housing 1050 each include corresponding parts of a locking mechanism that secures the modular electrical device 1000 inside the modular housing 1050. As shown, the locking mechanism is implemented with two flexible tabs 1010 and 1060 that engage when the modular electrical device 1000 is fully inserted into the modular housing 1050. In some implementations, one part of the locking mechanism could be a flexible tab while the other part could be a recess or catch configured to receive the tab. Other locking mechanisms could also be implemented to prevent the modular electrical device 1000 from inadvertently being removed from the modular housing 1050. For example, the mechanism could include quarter-turn fasteners, spring-loaded latches with a release button, detents, or the use of one or more screws that pass through the modular component to engage a threaded portion of the housing, similar to the securing structure 1214.

When the modular electrical device 1000 is inserted into the modular housing 1050, the tabs 1010 and 1060 engage, and are depressed until the tab 1010 passes the tab 1060. Once the tab 1010 passes the tab 1060, the tab 1010 locks into position behind the tab 1060, thereby securing the electrical device 1000 in the modular housing 1050. In some implementations, the modular electrical device 1000 can include a release mechanism that enables the electrical device 1000 to be ejected, or otherwise removed, from the module housing 1050. For example, the release mechanism can be a tab that depresses the tab 1010 so that it can move back out past the tab 1060.

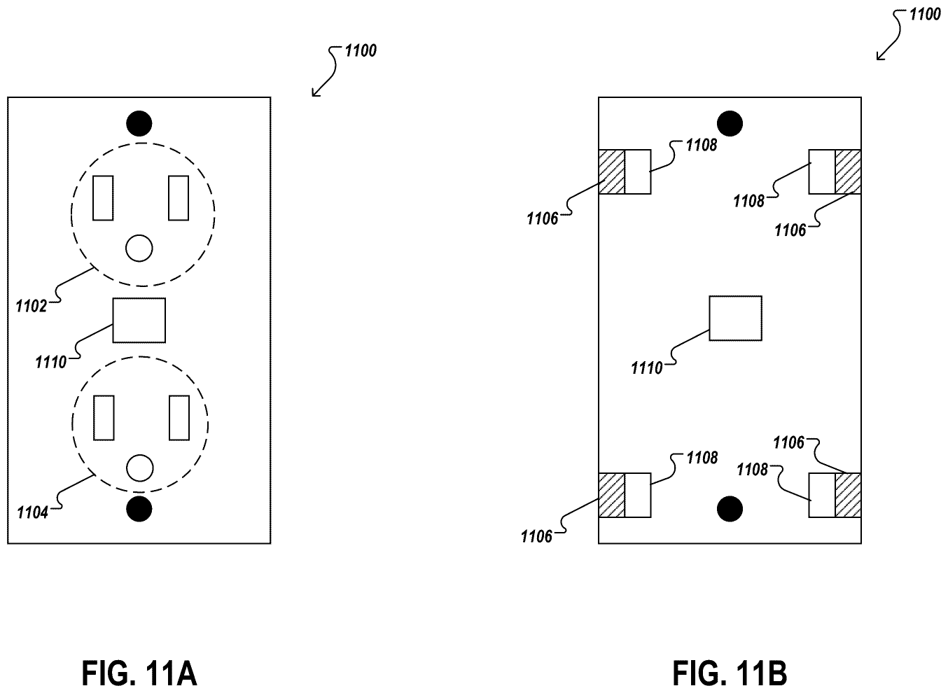

FIGS. 11A and 11B are illustrations (front and back views respectively) of a modular outlet 1100 that is configured to be inserted into a modular housing, such as the modular housing 950 discussed above. The modular outlet 1100 includes two traditional power outlets 1102 and 1104, which are configured to receive power plugs. The modular outlet has four conductors 1106 that are located within isolation channels 1108, which isolate the conductors 1106 from inadvertent touching or shorting. In some implementations, the conductors 1106 need not be within isolation channels 1104, but could be exposed because the conductors 1106 will only be energized (e.g., connected to power) once the modular outlet 1100 is inserted into the modular housing.

The modular outlet 1100 also includes a network connection 1110. The network connection 1110 can be, for example, an RJ4 or another appropriate connector that facilitates a connection of a networking cable, such as an Ethernet cable, in the back of the modular outlet 1100. The network cable connected to the back of the modular outlet 1100 can be, for example, a network cable that is connected to a network switch, router, or another component from which Internet connectivity is provided. The network connection 1110 can also be configured to facilitate a connection of another network cable to the front of the modular outlet 1100. For example, a network cable connecting the modular outlet 1100 to a computing device (or another device having a network connection port). In this way, the modular outlet 1100 can save space by allowing the network connection to be made through the same outlet as the power connection.

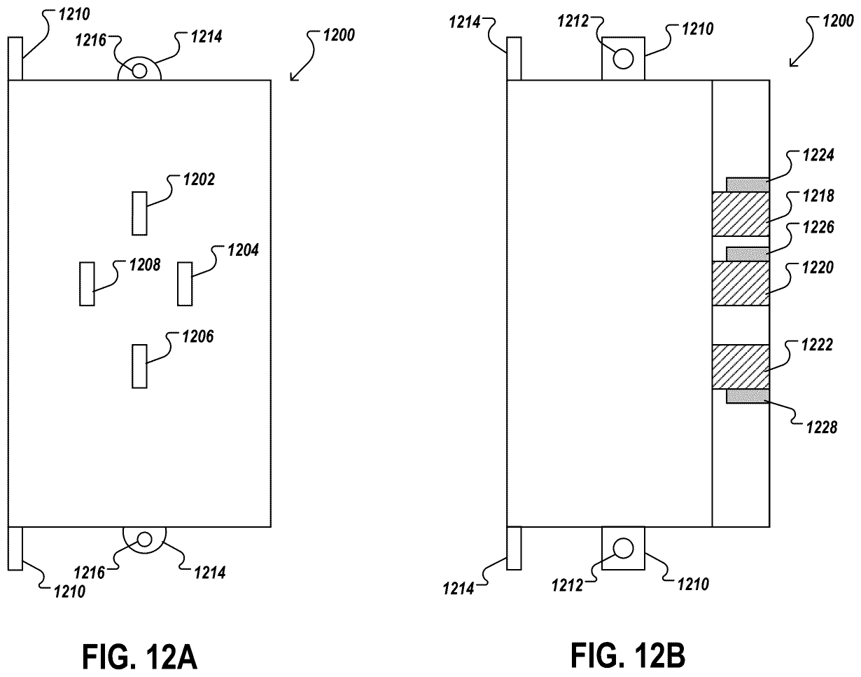

FIGS. 12A and 12B are illustrations of another modular housing 1200 (front and side views, respectively). As shown in FIG. 12A, the modular housing 1200 includes four isolation channels 1202-1208 in which four conductors (not shown in FIG. 12A) are housed. The isolation channels 1202-1208 are shown to be structurally similar to the receptacles/slots of a power outlet. Although four isolation channels are shown, more or fewer isolation channels can be formed in the modular housing 1200. For example, isolation channels can be provided for each of a hot, load, neutral, ground, and one or more traveler connections (e.g., for multi-way switching applications). Each of the isolation channels 1202-1208 can be configured to receive conductors of a modular outlet or modular switch similar to those discussed above. For example, the conductors on the modular switch/outlets previously discussed need not be housed within isolation channels, such that the conductors can be inserted into the isolation channels 1202-1208. The locations of the isolation channels 1202-1208 and the corresponding conductors on the modular switch/outlet can be selected so that they align and the conductors are inserted into the isolation channels 1202-1208 when the modular switch/outlet is inserted into the modular housing 1200.

The modular housing 1200 includes a set of mounting structures 1210 (e.g., tabs/projections) that are configured to facilitate connecting the modular housing 1200 to a wall stud. For example, the mounting structures 1210 can include mounting holes 1212 configured to received a nail or a screw, which can be used to fasten/secure the modular housing 1200 to the side of a wall stud.

The modular housing 1200 also includes a securing structure 1214. The securing structure 1214 is a tab or another portion of the modular housing 1200 that is configured to secure a modular switch/outlet to the modular housing 1200. For example, once a modular switch/outlet is inserted into the modular housing 1200, the modular switch/outlet, which can have a corresponding securing structure, can be secured to the modular housing 1200 by way of a machine screw or another fastener. In some implementations, the modular housing 1200 can include additional securing structures that can secure the modular housing 1200 to an existing (e.g., traditional) electrical housing that has already been installed. For example, as discussed in more detail below, the modular housing 1200 can be configured (e.g., sized) to be inserted into an existing traditional electrical housing that has already been installed, so as to enable the use of the modular housing 1200 without having to remove the existing traditional electrical housing. In this situation, the existing wiring will connect to the back of the modular housing 1200, which will cover those wires, and allow for plug and play installation of new modular switches/outlets as discussed throughout this document.

FIG. 12B shows the conductors 1218-1222 that are housed in the isolation channels 1202, 1204, and 1206. The conductor that is housed in the isolation channel 1208 is not shown in FIG. 12B because it is hidden by the conductor 1204 in this view. However, the description of the other conductors 1218-1222 is equally applicable to the conductor housed in the isolation channel 1208.

The conductors 1218-1222 can each have a corresponding wire port 1224-1228, which can be similar to those previously described. The wire ports 1224-1228 facilitate a connection between the conductors 1218-1222 and the corresponding building wiring (e.g., hot, neutral, ground, load, and/or traveler wires). In some implementations, the wire ports 1224-1228 can be preinstalled connectors that facilitate a quick physical connection between the wire ports 1224-1228 and the building wiring.

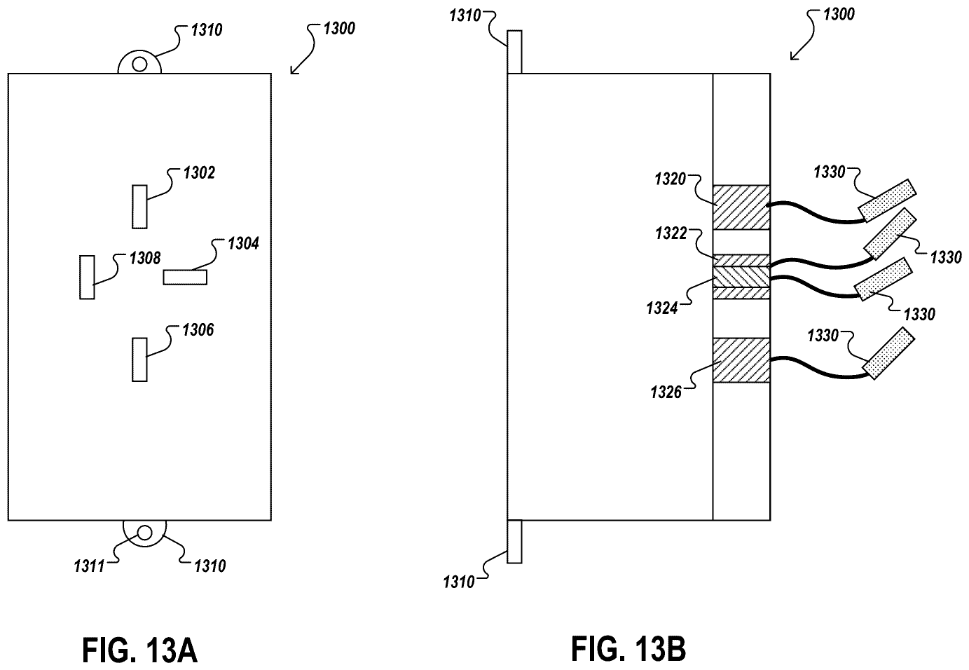

FIGS. 13A and 13B are illustrations of another example modular housing 1300. This modular housing 1300 is similar to the modular housing 1200 discussed above, but the arrangement of the isolation channels 1302-1304 differs. In this configuration, one of the isolation channels (e.g., 1304) is oriented in a different direction relative to the other isolation channels (e.g., 1302, 1306, and 1308). Orienting one of the isolation channels in a different direction prevents improper insertion of a modular switch/outlet into the modular housing 1300 because the corresponding conductors of the modular switch/outlet will not enter the isolation channels 1302-1308 if the conductors are not aligned correctly. As previously mentioned, more (or fewer) isolation channels can be formed in the modular housing 1300 depending on the use case.

The modular housing 1300 includes a securing structure 1310. In some implementations, the securing structure is configured to secure the modular housing 1300 to an existing traditional electrical housing that has already been installed in a building. For example, the securing structure can be a tab (or another portion) of the modular housing 1300 that is configured to align with screw holes in the traditional electrical housing so that the modular housing 1300 can be secured to the traditional electrical housing by way of a machine screw or another fastener. For example, the screw or fastener can be inserted through a screw hole 1311 formed in the securing structure. In this way, the modular housing 1300 can be used to convert an existing electrical housing to be compatible with modular switches/outlets, for example, by inserting the modular housing 1300 into the traditional electrical housing.

FIG. 13B shows an example electrical interface to existing wiring that is located within a traditional electrical housing. For example, the modular housing 1300 includes four wires 1312-1318 (one for each isolation channel 1302-1308 and corresponding conductor housed therein) that are configured to connect to the corresponding wiring of the building. Each of the wires 1312-1318 is connected to a corresponding conductor 1320-1326. In this example, the wires 1312-1318 can be secured to the building wiring, for example, using electrical couplers 1330, such as twist on wire connectors, butt splice connectors, or another appropriate electrical connector. In some implementations, rather than using wires, an electrical connector can be preconnected directly to each of the conductors 1320-1326 of the modular housing 1300, such that the building wires can be connected to the electrical connector.

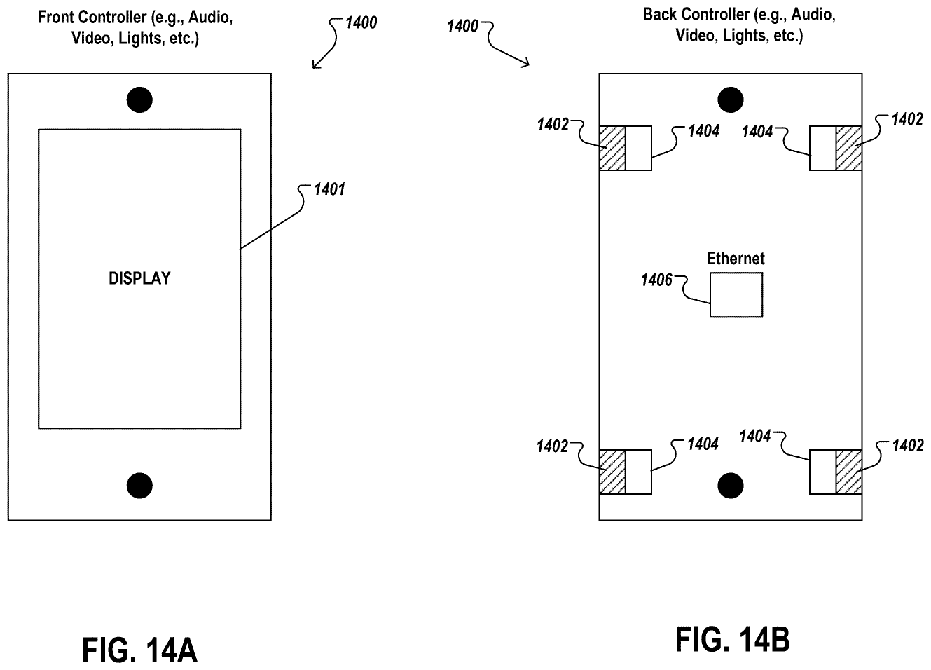

FIGS. 14A and 14B are illustrations of a front view and a back view, respectively, of an example modular controller 1400. The modular controller 1400 represents an example of an intelligent, configurable, and network-enabled modular electrical component that can be inserted into a modular housing, such as the modular housing 950 or 1200. The modular controller 1400 integrates advanced digital electronics with the standardized physical and electrical interface of the modular housing system.

As shown in the front view of FIG. 14A, the modular controller 1400 includes a display 1401, such as an LCD DISPLAY. The LCD DISPLAY can function as a user interface for providing information to a user and receiving input from a user. In some implementations, the LCD DISPLAY can be a color or monochrome liquid crystal display. The display may further include a resistive or capacitive touchscreen layer to allow a user to interact with graphical elements shown on the display, such as virtual buttons, sliders, or menus. The LCD DISPLAY can present various types of information, for example, the status of a connected electrical load (e.g., lights on/off, dimmer level), control menus for various connected systems (e.g., lighting, audio, video, security), configuration settings for the controller 1400, or data received from a local network or the internet.

In some implementations, the user interface presented on the LCD DISPLAY can be configurable, allowing a user to customize the graphical elements. For example, a user can select which controls are displayed, such as controls for lighting systems (e.g., virtual dimmers, on/off buttons), or controls for other systems. The layout, size, and type of these virtual controls can be adjusted to suit user preferences or the specific application of the controller 1400. This configurability allows the controller 1400 to be adapted for different rooms or functions, for example, prioritizing lighting controls in a living room or audio controls in a media room.

In some implementations, the graphical elements can also be configured to change automatically over time. For example, the user interface could adapt based on the time of day, displaying a high-contrast theme during daylight hours and a darker, low-light theme at night. The display could also change based on the time of year, for instance, by presenting a different color scheme or a set of seasonal controls during certain months.

In some implementations, the controller can also learn user interaction patterns over time and dynamically update the display to prioritize the controls a user is most likely to need. For example, if a user frequently adjusts the lighting controls in the evening, the controller can learn this pattern and automatically present the lighting controls more prominently during evening hours. This adaptive functionality can reduce the number of user inputs required to perform common tasks, thereby preventing the user from having to navigate through menus for frequently used functions.

The back view of the modular controller 1400 is shown in FIG. 14B. The back of the controller 1400 includes a plurality of conductors 1402, shown as four cross-hatched areas in the corners. These conductors 1402 are physically and electrically configured to mate with corresponding receiving terminals and conductors of a modular housing (e.g., receiving terminals 954 in housing 950, or 1052 in housing 1050), when the modular controller 1400 is inserted into the modular housing). The conductors 1402 allow the modular controller 1400 to draw operating power (e.g., via hot and neutral connections) from the building wiring via the modular housing and to control an electrical load (e.g., via a load connection).

In some implementations, the conductors 1402 are located within isolation channels 1404. The isolation channels 1404 can be configured to isolate the conductors 1402 from inadvertent touching or shorting, similar to the isolation channels 1004 described with reference to FIGS. 10A and 10B. When the controller 1400 is inserted into a compatible modular housing, the isolation channels 1404 can interface with corresponding features of the housing to ensure a secure and protected electrical connection is made between the conductors 1402 and the conductors of the housing.

The back of the modular controller 1400 also includes a network port 1406, such as an Ethernet port. The Ethernet port can be, for example, a standard RJ45 connector configured to establish a wired data connection to a local area network (LAN). This network connection enables the modular controller 1400 to communicate with other devices on the network, a central home automation hub, or the internet. For example, the controller 1400 can receive command packets from a remote device (e.g., a smartphone application) to control a connected load, and it can send status packets indicating its current state. This connectivity facilitates integration with smart home ecosystems, allows for remote control and monitoring, and can be used to receive software or firmware updates.

In some implementations, the Ethernet port can be configured to support Power over Ethernet (PoE), in accordance with standards such as IEEE 802.3af, 802.3at, or 802.3bt. In such a configuration, the modular controller 1400 could receive its operating power directly through the same Ethernet cable that provides the data connection, sourcing power from a PoE-enabled network switch or power injector located elsewhere on the network. This capability can simplify the wiring requirements for the modular housing into which the controller 1400 is inserted. For instance, the controller 1400 might not need to connect to the hot and neutral conductors of the building's main electrical system, relying solely on PoE for its own power while still using the housing's load conductor to control the connected electrical device.

To support these functionalities, the modular controller 1400 can include internal components such as a processor or microcontroller, memory (e.g., RAM, flash memory), and associated support circuitry. The processor can execute instructions to manage the LCD DISPLAY, process user inputs from a touchscreen, execute control logic for a connected load, and manage network communications via the Ethernet port. To manage heat generated by these electronic components, the modular controller 1400 can also include thermal management features. For example, the back of the controller could incorporate a metal heat sink, or the housing of the controller itself could be designed with ventilation channels to promote passive air cooling within the wall cavity. In some implementations, the internal processor could monitor an on-board temperature sensor and automatically reduce the display brightness or throttle its own performance to prevent overheating, ensuring the longevity and safe operation of the device.

In some implementations, the modular controller 1400 can further include one or more integrated sensors to enable environmental awareness and automation. For example, an ambient light sensor can be included to allow the controller to automatically adjust the brightness of its own display or to control connected lighting based on the amount of natural light in the room. An occupancy or motion sensor (e.g., a passive infrared (PIR) or microwave sensor) could be integrated to automatically turn lights on when a person enters a room and off when the room is vacant. Other sensors, such as temperature, humidity, or air quality sensors, could also be included, allowing the controller to serve as a comprehensive smart home hub.

In addition to control and sensor integration, the internal processor of an intelligent modular component, such as the modular controller 1400 or virtual switch 1500, can be configured to perform power and energy monitoring. The device can include internal circuitry, such as a current sensing resistor or a Hall effect sensor, to measure the real-time current and voltage passing through to the connected load. The processor can use these measurements to calculate various power quality metrics, such as instantaneous power consumption (in Watts), cumulative energy usage (in kilowatt-hours), power factor, and voltage levels. This information can be displayed to the user on the device's screen or transmitted over the network to a home automation system or smartphone application. This provides the technical advantage of enabling energy conservation, load diagnostics, and cost tracking, adding significant value and functionality to the modular component.

As a specific use case, the modular controller 1400 could be used to manage a home theater lighting system. A user could touch a virtual slider on the LCD DISPLAY to set a desired brightness for the lights. The internal processor would interpret this input and modulate the power delivered to the light fixtures through one of the rear conductor interfaces connected to the load conductor in the modular housing. Furthermore, a command received via the Ethernet port from a central home automation system (e.g., “movie mode”) could trigger the controller 1400 to automatically dim the lights to a preset level, demonstrating its remote-control and automation capabilities. The technical advantage of such a device is the provision of advanced, configurable control and network connectivity in a component that installs with the same ease and safety as the other modular components described herein.

In alternative implementations, other technologies could be used. For instance, the LCD DISPLAY could be an Organic Light Emitting Diode (OLED) or E-ink display. The user interface could also be supplemented with or replaced by physical buttons, dials, or status LEDs. The wired Ethernet port could be replaced by or supplemented with a wireless communication module, such as a Wi-Fi, Bluetooth, Zigbee, or Z-Wave radio, integrated within the housing of the controller 1400. In further implementations, the wireless communication module could support other protocols, such as Thread, to enable participation in a low-power, IP-based mesh network. This would facilitate interoperability with other smart home devices, for example, through an application-layer standard such as Matter. A trade-off could exist between a wired connection, which may offer higher reliability and data speeds, and a wireless connection, which may offer greater installation flexibility.

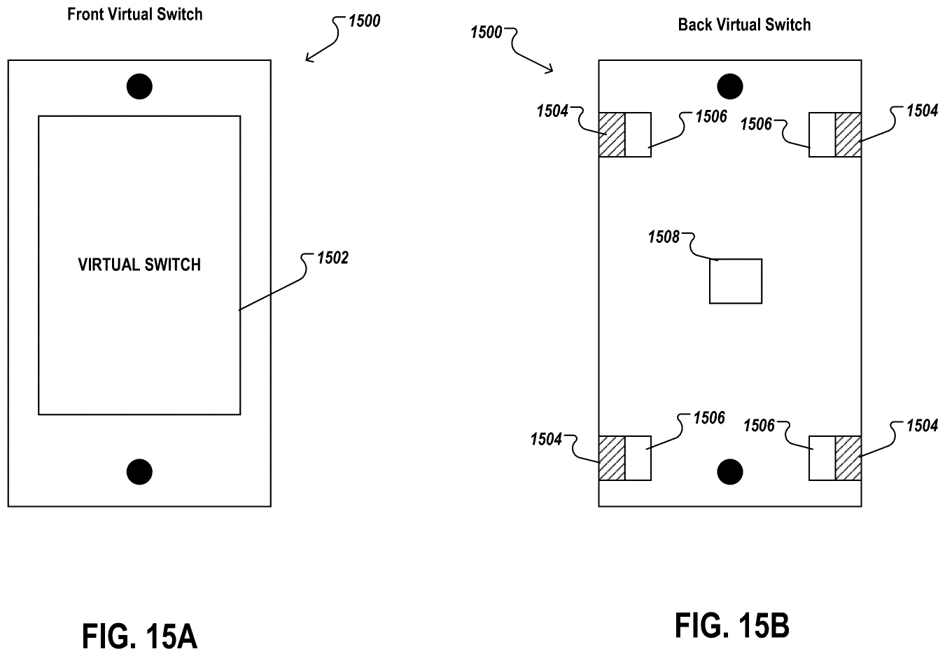

FIGS. 15A and 15B are illustrations of a front view and a back view, respectively, of an example modular virtual switch device 1500. The modular virtual switch device 1500 represents another example of an intelligent modular electrical component that can be inserted into a modular housing, such as the modular housing 950 or 1200. In contrast to the more general-purpose modular controller 1400, the modular virtual switch device 1500 is primarily configured to perform the function of a traditional electrical switch (e.g., a light switch), but replaces a physical, mechanical actuator with a software-defined, screen-based graphical user interface (GUI).

As shown in the front view of FIG. 15A, the modular virtual switch device 1500 includes a display 1502, such as a VIRTUAL SWITCH display. This display can be, for example, a liquid crystal display (LCD) or an organic light-emitting diode (OLED) display, and can be integrated with a touchscreen sensor, such as a capacitive touch sensor, to receive user inputs. The primary function of the VIRTUAL SWITCH display is to present a GUI that emulates the functionality of one or more physical switches for controlling a connected electrical load. For example, the GUI can present graphical elements such as a virtual toggle switch, a graphical push-button, or a vertical slider for dimming control. The display can also provide visual feedback to a user, such as by changing the color, brightness, or graphical representation of a virtual button to indicate the on/off state of the connected load.

The back view of the modular virtual switch device 1500 is shown in FIG. 15B. The back of the device 1500 includes a plurality of conductors 1504, shown as four cross-hatched areas in the corners. These conductors 1504 are physically and electrically configured to mate with the corresponding receiving terminals of a modular housing (e.g., the terminals within housing 950 or 1200) when the device 1500 is inserted into the internal void of such a housing. This connection allows the device 1500 to receive operating power (e.g., via hot and neutral conductors) from the building wiring and to provide a switched electrical connection to a load (e.g., via a load conductor).

In some implementations, the conductors 1504 are located within isolation channels 1506. The isolation channels 1506 are configured to isolate the conductors 1504 from inadvertent touching or shorting, similar to the isolation channels described elsewhere in this specification.

The back of the device 1500 may also include a central connector 1508, shown as an unlabeled rectangle. In some implementations, this central connector 1508 can be a data or service port, such as a Universal Serial Bus (USB) port, for performing firmware updates, initial configuration, or diagnostics. In other implementations, this port could be a proprietary diagnostic connector for factory testing or could be omitted entirely to reduce cost.

In some implementations, the central connector could be a network interface, similar to the network port 1406 described with reference to FIG. 14B. For example, the central connector could be an Ethernet port that enables the modular virtual switch device 1500 to connect to a local area network for remote control, integration with home automation systems, or to receive software updates. In some implementations, a wireless communication module (e.g., Wi-Fi, Zigbee, Z-Wave) could be included in place of or in addition to a wired network port to provide similar network connectivity.

To connect the user interface on the front to the electrical interfaces on the back, the modular virtual switch device 1500 includes internal electronic components. These components can include a processor or microcontroller configured to execute software instructions for rendering the GUI on the VIRTUAL SWITCH display, processing touch inputs from the user, and controlling the state of the connected electrical load. The internal components also include a switching element controlled by the processor. This switching element can be, for example, an electromechanical relay or a solid-state relay (e.g., a TRIAC), which physically opens or closes the electrical circuit between the input power conductor and the load conductor on the back of the device 1500.

As a specific use case, to turn on a light, a user can tap the graphical representation of a switch on the VIRTUAL SWITCH display. The internal processor detects this touch event and sends a signal to the internal switching element. The switching element closes, creating an electrical connection between the “hot” input conductor and the “load” output conductor on the back of the device 1500, thereby energizing the light fixture. The technical advantages of such a device include providing a user interface that can be aesthetically customized or updated via software, the potential to consolidate multiple switches into one software-defined interface, and the elimination of mechanical moving parts for increased longevity, all within the easy-to-install modular framework.

In alternative implementations, the user interface on the VIRTUAL SWITCH display could provide haptic feedback to simulate the tactile feel of a physical switch. The GUI could be reconfigurable to function as a simple on/off switch, a dimmer, or a multi-way switch in coordination with other similar devices on a network. A technical trade-off exists between using an internal electromechanical relay, which provides an audible click and is robust for various load types, and a solid-state relay like a TRIAC, which offers silent operation and enables smooth dimming but may have compatibility considerations with certain types of loads, such as some LED bulbs.

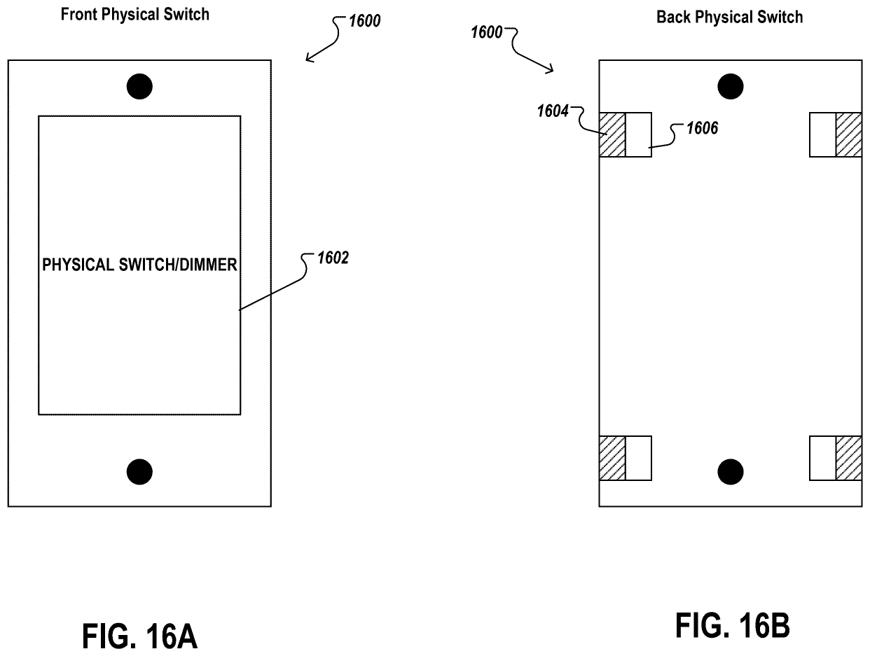

FIGS. 16A and 16B are illustrations of a front view and a back view, respectively, of an example modular physical switch device 1600. The modular physical switch 1600 represents another example of a modular electrical component configured to be inserted into the internal void of a modular electrical housing, such as the housing 950 or 1050. This device provides the functionality of a traditional electrical switch or dimmer, but is designed for safe, “plug and play” installation into the modular housing system. In contrast to the screen-based interfaces of the modular controller 1400 and virtual switch 1500, the modular physical switch 1600 provides a tangible, mechanical user interface, which may be preferred by some users for its tactile feedback, reliability, and simplicity. This allows the benefits of the modular housing system, such as safety and ease of installation, to be extended to conventional and widely understood user interfaces.

As shown in the front view of FIG. 16A, the primary user interface of the modular physical switch 1600 is a physical actuator 1602. The physical actuator 1602 is configured to receive a physical force from a user to change the state of an internal electrical circuit, thereby controlling an electrical load. The physical actuator 1602 can be implemented in various forms. For example, the physical actuator 1602 can be a rocker switch, a toggle switch, a paddle switch, or a push-button for on/off control. In other implementations, for dimming control, the physical actuator 1602 can be a rotary dial or a linear slider. The visible portions of the physical actuator 1602 and its surrounding faceplate can be made from various materials, such as different types of plastic (e.g., polycarbonate, PVC) or metal, to achieve different aesthetic or durability characteristics.

The back view of the modular physical switch 1600 is shown in FIG. 16B. The back of the device 1600 includes the electrical interfaces that are configured to physically and electrically mate with the corresponding plurality of receiving terminals of a modular electrical housing. These electrical interfaces are shown as four housing conductor interfaces 1604 located near the corners of the device. The housing conductor interfaces 1604 are configured to make a direct electrical connection with the conductors in a modular housing to receive line power and to connect to a load. The specific electrical role of each housing conductor interface 1604 can be pre-configured for different applications, such as connecting to line (hot), load, neutral, ground, or traveler wires. In some implementations, the housing conductor interfaces 1604 can be located within isolation channels 1606, which are configured to isolate the electrical conductors and ensure proper alignment and a secure connection upon insertion into a modular housing.

The modular physical switch 1600 includes an internal mechanism that mechanically and electrically links the physical actuator 1602 on the front to the housing conductor interfaces 1604 on the back. This mechanism can include an internal mechanical linkage and an electrical switching component. For a simple on/off switch, this electrical component can be a set of contacts that physically open and close a circuit. For a dimmer, this component could be an electronic circuit, such as a potentiometer or a TRIAC circuit, to modulate the flow of electricity to the load.

As a specific example and use case, the modular physical switch 1600 can be configured as a rocker switch to control a light fixture. When a user presses the lower portion of the physical actuator 1602, an internal mechanical linkage causes a set of electrical contacts to close. This completes a circuit between a “hot” housing conductor interface 1604 and a “load” housing conductor interface 1604 on the back of the device, thereby energizing the connected light fixture. The technical advantage of this device is that it combines the rapid, safe, and error-proof installation of the modular system with the familiarity and tactile feedback of a conventional mechanical switch.

Alternative implementations of the modular physical switch 1600 are possible to support a variety of wiring applications. For example, the internal mechanism and the configuration of the housing conductor interfaces 1604 can be arranged to function as a single-pole switch, a three-way switch, or a four-way switch, each requiring connection to the appropriate line, load, and traveler conductors via the modular housing.

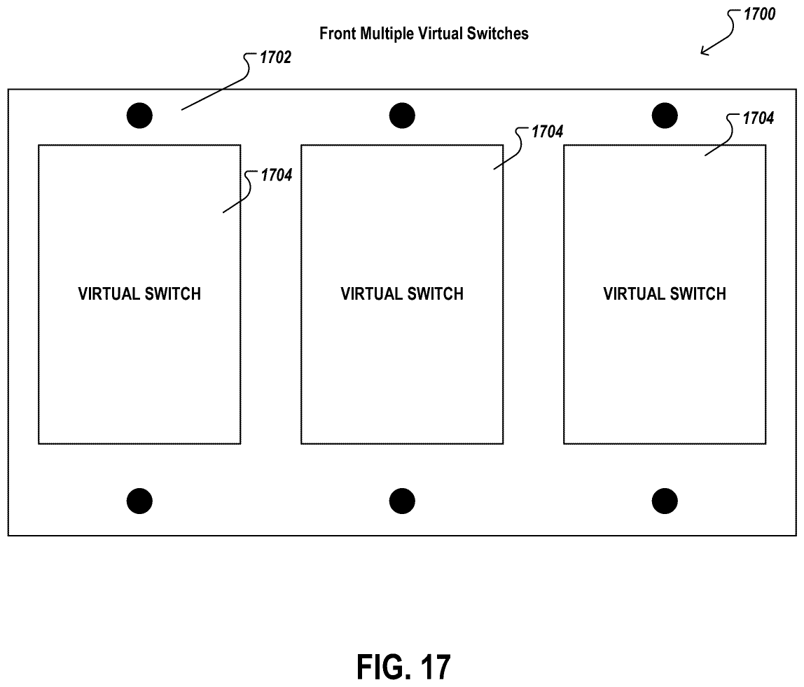

FIG. 17 is an illustration of a front view of an example modular multi-switch device 1700. The modular multi-switch device 1700 is specifically configured for a multi-gang application, such as a 3-gang electrical box, consolidating what would traditionally require the installation of three separate switch devices into a single, integrated modular electrical component. This device 1700 combines the functionality of multiple instances of the modular virtual switch device 1500 of FIG. 15 into one housing, which can provide a clean aesthetic and can simplify the installation process.

As shown in the front view, the modular multi-switch device 1700 includes a single, elongated faceplate 1702, which is sized to cover a multi-gang electrical housing opening. The faceplate 1702 includes a plurality of user interfaces. For example, as shown, the faceplate 1702 includes three distinct virtual switch interfaces 1704. Each virtual switch interface 1704 can be functionally similar to the virtual switch display 1502 of FIG. 15, and can include a display screen, such as an LCD or OLED display, with an integrated touchscreen sensor. Each virtual switch interface 1704 can be configured to present a graphical user interface for controlling a separate, associated electrical load. In some implementations, the three virtual switch interfaces 1704 can be included in a single display screen. In some implementations, the three virtual switch interfaces 1704 can be distributed over several display screens that are either adjacent to, or spaced apart from, each other.

The modular multi-switch device 1700 is configured to be inserted into a corresponding multi-gang modular electrical housing. Such a housing would provide the necessary sets of receiving terminals to connect each of the device's internal switches to separate electrical circuits (e.g., three different lighting loads). To facilitate this connection, the back of the modular multi-switch device 1700 (not shown) includes a plurality of housing conductor interfaces 1706. The housing conductor interfaces 1706 can be arranged in sets, with each set corresponding to one of the virtual switch interfaces 1704 on the faceplate 1702. For example, a first set of conductor interfaces can be electrically connected to a first load and controlled by a first virtual switch interface 1704, a second set can be connected to a second load and controlled by a second virtual switch interface 1704, and a third set can be connected to a third load and controlled by a third virtual switch interface 1704. These interfaces allow the device 1700 to draw operating power and independently control multiple separate electrical circuits via the multi-gang modular housing. The conductor interfaces can be similar to the conductor interfaces 1504, 1506 described with reference to FIGS. 15A and 15B.

The modular multi-switch device 1700 can be considered a specific implementation of a modular electrical component, which has been adapted for insertion into a multi-gang modular housing. For instance, in a large room with multiple lighting zones, the modular multi-switch device 1700 can be installed in a 3-gang modular housing. A user can tap the leftmost virtual switch interface 1704 to control the main ceiling lights, the middle interface to control accent lighting, and the rightmost interface to control a ceiling fan. The single, integrated device simplifies installation and provides a consistent user experience for controlling all three loads. The technical advantages of such a device can include a significant reduction in installation time for multi-gang setups, ensuring a perfectly aligned and aesthetically pleasing result compared to installing and aligning three separate devices, and enabling the potential for inter-switch logic (e.g., a master “all off” function) within a single, self-contained unit.

In some implementations, a similar multi-gang device could feature a mix of interface types on a single faceplate 1702, such as two virtual switch interfaces 1704 and one physical actuator 1602 for a dimmer. The device could also include a single, shared network interface (e.g., Ethernet or Wi-Fi) that provides network connectivity for all three switch functions, which can reduce component redundancy and cost. A technical trade-off may exist between using a single, more powerful central processor to manage all three interfaces versus using three smaller, independent microcontrollers. A single processor may be more cost-effective but creates a single point of failure, whereas a distributed architecture could offer more resilience. In simple terms, this device takes three separate smart switches and combines them into one seamless panel. Instead of installing and aligning three individual boxes in the wall, an installer can now snap in this single, three-in-one unit for a faster, cleaner installation.

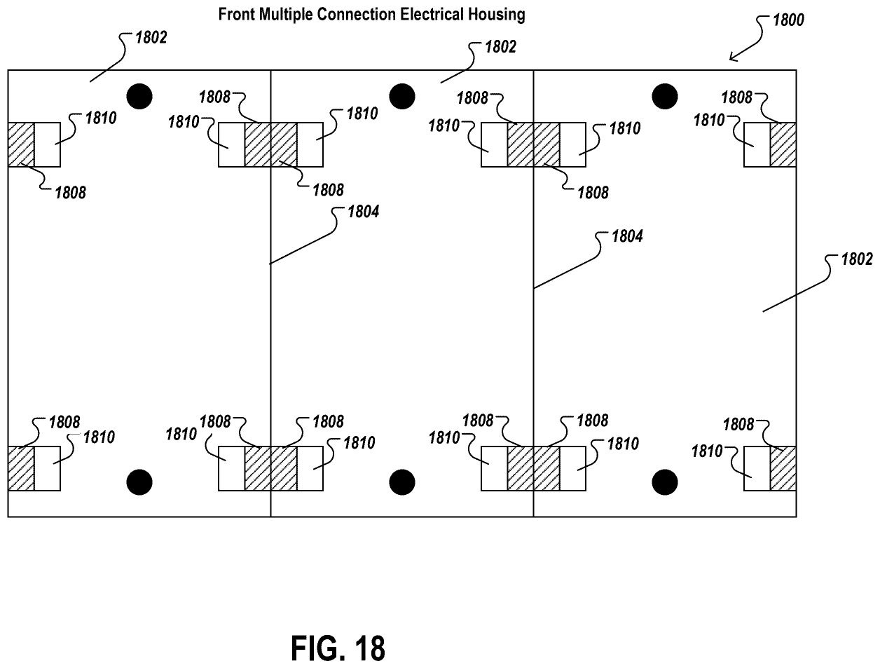

FIG. 18 is an illustration of a front view of an example modular multi-gang housing 1800. The modular multi-gang housing 1800 provides the structural and electrical infrastructure for multi-gang installations and serves as the receiving counterpart for either a single, integrated multi-gang device (such as the modular multi-switch device 1700) or a plurality of individual single-gang modular electrical components (such as the modular physical switch 1600 or the modular outlet 800). In contrast to the single-gang housings described in previous figures (e.g., housing 950, 1200), the modular multi-gang housing 1800 has an elongated form factor designed to be installed in a standard multi-gang wall opening.

The internal void of the modular multi-gang housing 1800 is divided into a plurality of distinct bays 1802. As illustrated, the housing 1800 includes three such bays 1802, which are physically and electrically separated from one another by one or more internal dividing walls 1804. Each bay 1802 is configured to receive a corresponding modular electrical component, providing the foundation for a “plug and play” installation of one or more modular components. In some implementations, the bays 1802 can be positioned to line up with the user interfaces (e.g., virtual switch interfaces 1704) of a corresponding modular multi-switch device to simplify the installation and user experience. The modular electrical components can be single gang components (e.g., the modular physical switch 1600 or the modular outlet 800) or can be multi-gang components (e.g., the modular multi-switch device 1700).

Within each bay 1802, the housing 1800 includes a complete and independent set of a plurality of receiving terminals. Each receiving terminal includes an electrical conductor 1808 that is housed within a protective isolation channel 1810. The provision of an independent set of receiving terminals in each of the three bays 1802 allows for the independent control of separate electrical circuits from a single multi-gang location. To facilitate this, the modular multi-gang housing 1800 includes a plurality of wire ports (not shown) located on its back or sides. These wire ports are arranged in groups, with each group electrically connected to the conductors 1808 of a single, corresponding bay 1802. This configuration enables an electrician to connect building wires for multiple, separate circuits (e.g., three different lighting loads) to the housing 1800 during the rough-in phase of construction.

The modular multi-gang housing 1800 represents a specific implementation of a modular electrical housing. Its internal void is partitioned into the multiple bays 1802, and each bay 1802 contains its own set of multiple receiving terminals, with the overall housing 1800 providing multiple wire ports to connect to building wiring.

The modular multi-gang housing 1800 supports multiple installation scenarios. For example, the housing 1800 can receive a single modular multi-switch device 1700. The rear connectors of the device 1700 can be configured to align with and plug into the respective sets of receiving terminals 1806 in each of the three bays 1802, establishing control over three separate circuits with a single installation action. Alternatively, the housing 1800 can receive three separate single-gang modular components. For example, a modular physical switch 1600 could be inserted into the first bay 1802, a modular outlet 800 into the second bay 1802, and a modular virtual switch 1500 into the third bay 1802, allowing for a custom combination of functions within a single multi-gang unit.

The technical advantages of the modular multi-gang housing 1800 can include simplifying the complex wiring of traditional multi-gang boxes, ensuring perfect alignment of devices, and providing a standardized platform that dramatically speeds up both rough-in and final installation for multi-gang locations.

In alternative implementations, the housing 1800 could be manufactured with a different number of bays 1802, such as two, four, or more, to accommodate various standard multi-gang configurations. In some implementations, certain common connections, such as for ground or neutral wires, could be internally connected across all bays 1802 via an integrated busbar to simplify building wiring by reducing the number of wire pigtails required. The housing 1800 can be made of a high-strength, non-conductive plastic and can include integrated mounting structures (e.g., similar to 1210) for attachment to building studs. In simple terms, this multi-gang housing is like a pre-wired, three-slot cartridge holder for electrical devices. An electrician connects the main building wires to the back of this one box, and then different switches or outlets can be safely snapped into each slot without any further wiring.

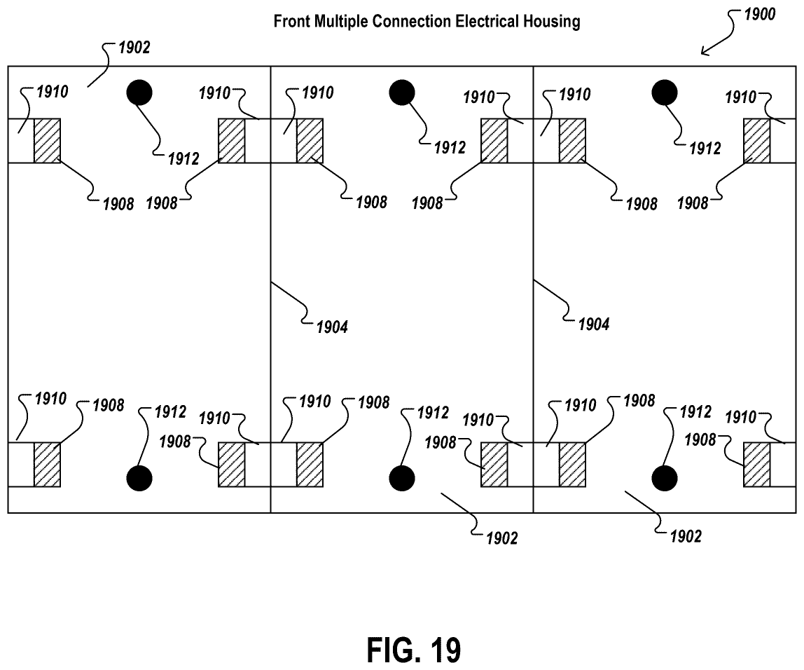

FIG. 19 is an illustration of a front view of an alternative implementation of a modular multi-gang housing 1900. This configuration provides the same fundamental “plug and play” structural and electrical foundation as the housing 1800 shown in FIG. 18, but is specifically configured to accommodate modular electrical components that have differently positioned conductor interfaces. The provision of multiple housing configurations increases the versatility of the overall modular system by supporting a wider variety of component designs.

The modular multi-gang housing 1900 has an internal void that is divided into a plurality of distinct bays 1902 by one or more internal dividing walls 1904. Each bay 1902 is configured to receive a single modular electrical component, either in a single-gang configuration (e.g., modular physical switch 1600) or a multi-gang configuration (e.g., modular virtual switch 1500). Within each bay 1902, the housing 1900 includes a complete and independent set of a plurality of receiving terminals 1906. Each receiving terminal 1906 includes an electrical conductor 1908 and an associated protective isolation channel 1910.

A difference between the configuration shown in FIG. 19 and that of FIG. 18 is the spatial relationship between these components. In the modular multi-gang housing 1900, each conductor 1908 is positioned offset from the adjacent internal dividing wall 1904. The corresponding isolation channel 1910 is formed in the space between the conductor 1908 and the internal dividing wall 1904. This arrangement provides electrical and physical separation, but in a different geometric layout compared to the housing 1800 where the conductors are located adjacent to the dividing walls. The implied back side of the housing 1900 includes a plurality of wire ports (not shown), which can be arranged in groups with each group electrically connected to the conductors 1908 of a corresponding bay 1902.

The modular multi-gang housing 1900 represents another specific implementation of a modular electrical housing, and demonstrates that the modular electrical housing can have various geometric arrangements of the receiving terminals within the internal void. For example, an installer may have a set of modular switches that are designed with conductor interfaces offset from the component's centerline. The modular multi-gang housing 1900 is specifically configured to receive these components, ensuring that the offset interfaces on the switch align with the offset conductors 1908 within each bay 1902 of the housing. The technical advantage of providing multiple housing configurations is that the system can accommodate a wider variety of modular component designs, such as components with different internal layouts or from different manufacturers, while maintaining the core benefits of standardized, safe, and rapid installation.

In some implementations, a single multi-gang housing could have mixed configurations, where one bay 1902 has the offset conductor arrangement of FIG. 19, while an adjacent bay has the wall-adjacent configuration of FIG. 18, to support specific combinations of modular components. Furthermore, the specific offset and shape of the isolation channels 1910 can serve as a mechanical keying feature, physically preventing the insertion of an incompatible modular component into a bay 1902. In simple terms, this can be thought of as a different version of the three-slot cartridge holder for electrical devices. While the previous version had all the electrical contacts pushed to one side of each slot, this version has the contacts located more towards the middle. This allows it to work with a different style of pop-in switch or outlet, making the whole system more flexible and universal.

The black circles in each of the housings (e.g., 1912 in FIG. 19) represent connection points where modules can be affixed to the housings. For example, a module can be secured to the housings by way of screws or other fasteners. In some implementations, the housings (e.g., 1800, 1900) can be made from a non-conductive material and electrically insulate the wiring from the modules. In some implementations, the housings (e.g., 1800, 1900) can be made from steel or other conductive materials and be included as a ground connection for the electrical module. Further, although the housings (e.g., 1800, 1900) are shown with four corners, the housings can include greater or fewer corners.

In some implementations, the bays (e.g., 1802, 1902) can have a geometric shape of a cube, a rectangle, a pentagon, an octagon, a hexagon, or a different geometric shape.

### Method of Installation and Use

The modular electrical system provides for a streamlined and safe method of installing electrical components, which can be divided into two primary phases: a rough-in phase and a finishing phase.

During the rough-in phase of construction, a modular electrical housing (e.g., 100, 950, 1200, 1800) is installed. The housing is first mechanically secured to a building structure, such as a wall stud, using its integrated mounting structures (e.g., 1210). A licensed electrician then routes the building's electrical wiring (e.g., hot, neutral, ground, and load wires) to the housing. The electrician connects these wires to the plurality of wire ports (e.g., 134, 1055) on the back or sides of the housing. This action establishes a permanent and secure electrical connection between the building wiring and the plurality of conductors located within the housing's receiving terminals. At the conclusion of this phase, all high-voltage wiring is complete, and no exposed conductors remain accessible from the front of the housing, completing the work required by the electrician in a single visit.

During the finishing phase, which occurs after drywall and painting are complete, a modular electrical component (e.g., 800, 1600, 1400) is installed. This step can be performed by a builder, finisher, or homeowner without needing to interact with the building wiring. The user aligns the back portion of the modular electrical component with the internal void of the installed modular housing and pushes it into place. During insertion, the housing conductor interfaces on the component mate with the corresponding receiving terminals of the housing, establishing a secure, plug-and-play electrical connection. If a locking mechanism (e.g., 1010, 1060) is included, the component audibly and physically clicks into place. The component can then be fully secured using fasteners, such as screws. This method provides the technical advantage of bifurcating the installation process, separating the skilled electrical work from the simple, safe mechanical installation of the final device, thereby reducing costs and increasing safety and flexibility.

In some implementations, the modular housings and modular electrical components can be configured for use in damp or outdoor locations. To achieve this, a compressible gasket or seal can be incorporated into the system. For example, a modular housing could feature a groove around the perimeter of its front opening, and a corresponding modular component could include a matching elastomeric gasket (e.g., made of silicone or rubber) on the back of its faceplate. When the modular component is inserted and secured in the housing, the gasket would be compressed between the faceplate and the housing, creating a weather-resistant seal. This seal can be designed to meet specific ingress protection (IP) ratings, such as IP44 or higher, to protect the internal electrical connections from moisture, dust, and other environmental contaminants, thereby expanding the applicability of the modular system to a wider range of installation environments.

The modular electrical system, including the modular electrical housings and modular electrical components, is designed to comply with applicable safety standards and electrical codes, such as the National Electrical Code (NEC). Furthermore, the components can be constructed from materials and designed to be suitable for listing and labeling by a Nationally Recognized Testing Laboratory (NRTL), such as UL (Underwriters Laboratories), which is a general requirement for electrical equipment.

The modular electrical housings are designed to meet the requirements for outlet, device, and junction boxes. The housings, when constructed from non-conductive plastic, comply with standards for nonmetallic boxes. The integrated mounting structures (e.g., 1210) are configured to securely fasten the housing to building structures, such as wall studs. The housings fully enclose the electrical connection points, protecting the building wiring and terminals from physical damage and preventing the spread of fire, in alignment with the fundamental safety principles.

The modular connection system provides a means of creating electrical connections that meets the safety and reliability principles of the NEC. While traditional wiring methods involve screw terminals or push-in connectors, the disclosed system achieves a secure and reliable connection through several features. The isolation channels (e.g., 118, 904, 1202) fully shroud the electrical conductors, preventing accidental contact with live parts, a core safety principle. The use of keyed isolation channels (e.g., 218) and oriented receptacles (e.g., 1304) ensures proper alignment and polarity, preventing the mis-wiring of hot, neutral, and ground conductors, thereby complying with the intent of the NEC. The inclusion of a locking mechanism (e.g., 1010, 1060) ensures that the modular component is mechanically secured within the housing, preventing accidental disconnection and exposure of live conductors, consistent with the secure mounting requirements for devices in the NEC.

Thus, particular implementations of the subject matter have been described. Other implementations are within the scope of the following claims. The descriptions of the various implementations of the present disclosure have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A modular electrical housing, comprising:

2. The modular electrical housing of claim 1, wherein each of the plurality of receiving terminals comprises an isolation channel, and wherein each of the corresponding conductors is located within a respective isolation channel.

3. The modular electrical housing of claim 2, wherein at least one isolation channel is a keyed isolation channel having a shape different from other isolation channels in the internal void to ensure a pre-specified orientation of the modular electrical component when inserted into the modular electrical housing.

4. The modular electrical housing of claim 1, further comprising a locking mechanism configured to secure the modular electrical component within the internal void.

5. The modular electrical housing of claim 1, wherein the internal void is partitioned into a plurality of distinct bays by one or more internal dividing walls, and wherein each of the plurality of distinct bays includes a corresponding set of the plurality of receiving terminals.

6. A modular electrical component for insertion into a modular electrical housing, comprising:
a front face comprising a user interface;
a back portion configured to be inserted into an internal void of the modular electrical housing; and
a plurality of housing conductor interfaces located on the back portion, each of the plurality of housing conductor interfaces comprising a conductor configured to electrically connect with a corresponding receiving terminal of the modular electrical housing when the modular electrical component is inserted into the modular electrical housing.

7. The modular electrical component of claim 6, wherein the user interface comprises a physical actuator configured to control an electrical load.

8. The modular electrical component of claim 6, wherein the user interface comprises one or more electrical power receptacles.

9. The modular electrical component of claim 6, wherein the user interface comprises a display screen configured to present a graphical user interface.

10. The modular electrical component of claim 9, further comprising a network port configured to establish a data connection to a local area network.

11. The modular electrical component of claim 6, wherein at least one of the plurality of housing conductor interfaces is a keyed housing conductor interface having a shape configured to mate with a corresponding keyed receiving terminal of the modular electrical housing to ensure a pre-specified orientation of insertion.

12. A modular electrical system, comprising:
an internal void defined by two or more walls of a modular electrical housing;
a plurality of receiving terminals, including a corresponding plurality of conductors, located within the void; and
a plurality of wire ports configured to connect to electrical wiring of a building and provide an electrical connection between the plurality of conductors and the plurality of wire ports.

13. The modular electrical system of claim 12, comprising:
a modular electrical component configured for insertion into the internal void of the modular electrical housing, the modular electrical component comprising:
a front face comprising a user interface;
a back portion configured to be inserted into the internal void; and
a plurality of housing conductor interfaces located on the back portion, each of the plurality of housing conductor interfaces configured to electrically connect with a corresponding receiving terminal of the modular electrical housing when the modular electrical component is inserted into the modular electrical housing.

14. The modular electrical system of claim 13, wherein at least one of the plurality of receiving terminals of the modular electrical housing is a keyed receiving terminal having a shape different from other receiving terminals, and wherein at least one of the plurality of housing conductor interfaces of the modular electrical component is a keyed housing conductor interface having a shape configured to mate with the keyed receiving terminal to ensure a pre-specified orientation of insertion.

15. The modular electrical system of claim 13, further comprising a locking mechanism having corresponding parts on the modular electrical housing and the modular electrical component, the locking mechanism configured to secure the modular electrical component within the internal void of the modular electrical housing.

16. The modular electrical system of claim 13, wherein the user interface of the modular electrical component comprises a physical actuator configured to control an electrical load.

17. The modular electrical system of claim 13, wherein each of the plurality of receiving terminals of the modular electrical housing comprises an isolation channel, and wherein each of the plurality of housing conductor interfaces of the modular electrical component is configured to be inserted into a corresponding isolation channel.

18. The modular electrical system of claim 13, wherein the user interface of the modular electrical component comprises a display screen configured to present a graphical user interface.

19. The modular electrical system of claim 18, wherein the modular electrical component further comprises a network port configured to establish a data connection to a local area network.

20. The modular electrical system of claim 12, wherein the internal void of the modular electrical housing is partitioned into a plurality of distinct bays by one or more internal dividing walls, and wherein each of the plurality of distinct bays includes a corresponding set of the plurality of receiving terminals.
